(19) United States
(12) Patent Application Publication
(10) Pub. No.: US 2026/0304256 A1
(43) Pub. Date: Oct. 1, 2026

(54) METHODS, DEVICES, AND MEDIUM FOR COMMUNICATION

(71) Applicant: NEC Corporation, Tokyo (JP)

(72) Inventors: You LI, Beijing (CN); Gang WANG, Beijing (CN)

(73) Assignee: NEC Corporation, Tokyo (JP)

(21) Appl. No.: 18/880,495

(22) PCT Filed: Jul. 5, 2022
(86) PCT No.: PCT/CN2022/104008

§ 371 Date: Dec. 31, 2024

(51) Int. Cl. H04W 36/00; H04W 88/04

(52) U.S. Cl. CPC H04W 36/033; H04W 88/04

(57) ABSTRACT

Embodiments of the present disclosure relate to methods, devices and computer readable media for communication. According to embodiments of the present disclosure, a communication method implemented at a network device is provided. The communication method comprises: determining, at a first network device, a path switch for a terminal device from a first path including the first network device to a second indirect path including a second network device; and transmitting, to the second network device, a handover request message including information to indicate the path switch to candidate relay and information on candidate relay user equipment (UE) for the second indirect path.

### FIELD

Example embodiments of the present disclosure generally relate to the field of communication techniques and in particular, to methods, devices, and a computer readable medium for communication.

### BACKGROUND

Sidelink transmission and reception over the PC5 interface are supported when a first terminal device (also referred to as “UE” which is short for “user equipment”) is inside Next Generation Radio Access Network (NG-RAN) coverage, irrespective of which Radio Resource Control (RRC) state the UE is in.

When the first terminal device moves to some place where the direct communication with a first network device (also referred to as eNB or gNB or TRP, etc.), the first terminal device may experience a degradation of communication performance.

To maintain the communication performance of the first terminal device, it is proposed that the first terminal device may switch to communicate with a second network device instead, possibly via a second terminal device, which plays the role of the relay for the first terminal device to communicate with the second network device. However, the specific implementation is still needed to be discussed.

### SUMMARY

In general, example embodiments of the present disclosure provide methods, devices and a computer storage medium for communication.

In a first aspect, there is provided a method for communication. The method comprises: determining, at a first network device, a path switch for a terminal device from a first path including the first network device to a second indirect path including a second network device; and transmitting, to the second network device, a handover request message including first information to indicate the path switch to a candidate relay user equipment (UE) for the second indirect path and second information on the candidate relay UE.

In a second aspect, there is provided a method for communication. The method comprises: receiving, at a second network device from a first network device, a handover request message for a path switch associated with a terminal device from a first path including the first network device to a second indirect path including the second network device, the handover request message including first information to indicate the path switch to a candidate relay UE for the second indirect path and information on the candidate relay UE; and transmitting, to the candidate relay UE, a radio resource control (RRC) reconfiguration message for the path switch.

In a third aspect, there is provided a terminal device. The terminal device comprises a processor and a memory. The memory is coupled to the processor and stores instructions thereon. The instructions, when executed by the processor, cause the terminal device to perform the method according to the first aspect above.

In an fourth aspect, there is provided a network device. The network device comprises a processor and a memory. The memory is coupled to the processor and stores instructions thereon. The instructions, when executed by the processor, cause the network device to perform the method according to the second aspect above.

In a fifth aspect, there is provided a computer readable medium having instructions stored thereon. The instructions, when executed on at least one processor, causing the at least one processor to carry out the method according to the first aspect or the second aspect above.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1A illustrates an example communication system 100 in which some embodiments of the present disclosure can be implemented;

FIG. 1B illustrates an example signaling chart illustrating communication process 150 in accordance with some embodiments of the present disclosure;

FIG. 2A illustrates an example signaling chart illustrating communication process 200 in accordance with some embodiments of the present disclosure;

FIG. 2B illustrates an example signaling chart illustrating communication process 250 in accordance with some embodiments of the present disclosure;

FIG. 3 illustrates another example signaling chart illustrating communication process 300 in accordance with some embodiments of the present disclosure;

FIG. 4 illustrates a flow chart of an example method 400 in accordance with some embodiments of the present disclosure;

FIG. 5A illustrates an example signaling chart illustrating communication process 500 in accordance with some embodiments of the present disclosure;

FIG. 5B illustrates another signaling chart illustrating communication process 550 in accordance with some embodiments of the present disclosure;

FIG. 6 illustrates a flow chart of an example method 600 in accordance with some embodiments of the present disclosure;

FIG. 7 illustrates a flow chart of an example method 700 in accordance with some embodiments of the present disclosure;

FIG. 8A illustrates a signaling chart illustrating communication process 800 in accordance with some embodiments of the present disclosure;

FIG. 8B illustrates a signaling chart illustrating communication process 880 in accordance with some embodiments of the present disclosure;

FIG. 8C illustrates a signaling chart illustrating communication process 890 in accordance with some embodiments of the present disclosure;

FIG. 9 illustrates a signaling chart illustrating communication process 900 in accordance with some embodiments of the present disclosure;

FIG. 10 illustrates a signaling chart illustrating communication process 1000 in accordance with some embodiments of the present disclosure;

FIG. 11 illustrates a signaling chart illustrating communication process 1100 in accordance with some embodiments of the present disclosure;

FIG. 12 illustrates a signaling chart illustrating communication process 1200 in accordance with some embodiments of the present disclosure;

FIG. 13 illustrates a flowchart of an example method 1300 in accordance with some embodiments of the present disclosure;

FIG. 14 illustrates a flowchart of an example method 1400 in accordance with some embodiments of the present disclosure;

FIG. 15 illustrates a simplified block diagram of a device 1500 that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Tings (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “terminal device” refers to any device having wireless or wired communication capabilities. Examples of terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also be incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a satellite, a unmanned aerial systems (UAS) platform, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The terminal device or the network device may have Artificial intelligence (AI) or machine learning capability. It generally includes a model which has been trained from numerous collected data for a specific function, and can be used to predict some information.

The terminal device or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network device under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, or channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G)networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

In the context of the present disclose, the terms “acknowledgement”, “positive acknowledgement”, “ACK” can be used interchangeably.

In the context of the present disclose, when a network connection is referred to as “direct”, it means one mode of network connection, where there is no relay UE between a UE and the 5G network (also referred to as “gNB” in the present disclosure). In this case, the path between the UE and gNB is referred to as a “direct path”. Further, when a network connection is referred to as “indirect”, it means one mode of network connection, where there is a relay UE between a UE and the 5G network. In this case, the path between the UE and gNB via a relay UE is referred to as an “indirect path”.

In the context of the present disclose, the term “path switch” means there is a change in the path along which a UE connects to gNB. “Path switch” of the UE may be any of the following: (1) a first UE connects to a first gNB directly, and switches to (i) connect to the same first gNB via a relay UE served by the first gNB; or (ii) connect to a second gNB directly (such a scenario is also referred to as “handover”); or (iii) connect to a second gNB via a relay UE served by the second gNB; (2) the first UE connects to a first gNB via a relay UE, and switches to (i) connect to the first gNB directly (without via the relay UE); or (ii) connect to a second gNB directly; or (iii) connect to a second gNB via a relay UE served by the second gNB. It is to be understood that these examples are listed here only for illustrative purposes, without suggesting any limitation as to the scope of the present disclosure.

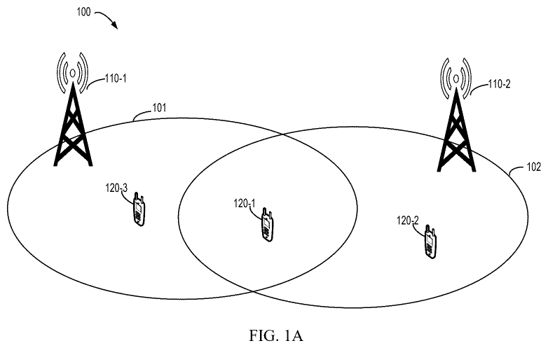

FIG. 1A illustrates an example communication system 100 in which some embodiments of the present disclosure can be implemented. The communication system 100, which is a part of a communication network, includes network devices 110-1 and 110-2 (also referred as gNB1 110-1 and gNB2 110-2 in the following) and terminal devices 120-1, 120-2 and 120-3 (also referred as UE1 120-1, UE2 120-2 and UE3 110-3 in the following). In the following, the network device 110-1 may be referred to as a first network device, and the network device 110-2 may be referred to as a second network device. The network devices 110-1 and 110-2 may be collectively referred to as “network device 110” or “gNB 110” or individually referred to as a “network device 110” or “gNB 110”. The terminal devices 120-1, 120-2 and 120-3 may be collectively referred to as “terminal device 120” or “UE 120” or individually referred to as a “terminal device 120” or “UE 120”.

As illustrated in FIG. 1A, gNB1 110-1 has a coverage area comprising cell 101, and UE1 120-1 and UE3 120-3 camp on the cell 101 and are served by gNB1 110-1. gNB2 110-2 has a coverage area comprising cell 102, and UE2 120-2 are served by gNB2 110-2. In other words, gNB1 110-1 provides network connection to UE1 120-1 and UE3 120-3, and gNB2 110-2 provides network connection to UE2 120-2.

In the system 100, a link from gNB 110 to UE 120 is referred to as a downlink (DL), while a link from UE 120 to gNB 110 is referred to as an uplink (UL). In downlink, gNB 110 is a transmitting (TX) device (or a transmitter) and UE 120 is a receiving (RX) device (or a receiver). In uplink, UE 120 is a transmitting TX device (or a transmitter) and gNB 110 is a RX device (or a receiver). It is to be understood that gNB 110 may provide one or more serving cells. In some embodiments, gNB 110 can provide multiple cells.

gNB 110 can provide services to UE 120, and gNB 110 and UE 120 may communicate data and control information with each other. In other words, gNB 110 is the serving gNB of UE 120. In some embodiments, gNB 110 and UE 120 may communicate with direct channels. In one example, gNB1 110-1 and UE1 120-1 may communicate with direct links, i.e., without via any other TRP (like a relay which relays UL transmission from UE1 120-1 to gNB1 110-1, and relays DL transmission from gNB1 110-1 to UE1 120-1). In another example, gNB1 110-1 and UE1 120-1 may communicate with indirect links via UE3 110-3, which play the role of a relay. In this case, UE3 110-3 may relay UL transmission from UE1 120-1 to gNB1 110-1, and may relay DL transmission from gNB1 110-1 to UE1 120-1.

The communications in the communication system 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols.

It is to be understood that the numbers of devices (including UE 120 and gNB 110) and their connection relationships and types shown in FIG. 1A are only for illustrative purposes without suggesting any limitation. The communication system 100 may include any suitable numbers of devices adapted for implementing embodiments of the present disclosure.

FIG. 1B illustrates an example signaling chart illustrating communication process 150 in accordance with some embodiments of the present disclosure. Only for the purpose of discussion, the process 150 will be described with reference to FIG. 1. The process 150 may involve UE 120 and gNB 110. More specifically, the process 150 may involve a candidate relay UE 120-2 which is shown as UE2, a source gNB 110-1 shown as gNB1 and a target gNB 110-2 shown as gNB2. As another example, the candidate relay UE 120-2 may also be referred to as a target relay UE. In some embodiments, gNB 110-2 can also provide services to UE 120-2, and gNB 110-2 and UE 120-2 may communicate data and control information with each other. In other words, gNB 110-2 is the serving gNB of UE 120-2.

gNB1 110-1 may determine 214 a path switch for a first UE (not shown in FIG. 1B) from a first path including gNB1 110-1 to a second indirect path including gNB2 110-2. The second indirect path may possibly also include a candidate relay UE (for example, UE2 120-2 as illustrated in FIG. 1B).

Then gNB1 110-1 may further transmit 216 a handover (HO) request message 202 to gNB2 110-2, and the HO request message may include at least one of first information to indicate the path switch to the candidate relay UE (for example, UE2 120-2 as illustrated in FIG. 1B) for the second indirect path and second information on the candidate relay UE. In one example, the HO request message may include both first information to indicate the path switch to the candidate relay UE for the second indirect path and second information on the candidate relay UE. In another example, the HO request message may include the second information on the candidate relay UE for the second indirect path but not include the first information to indicate the path switch to the candidate relay UE. On the other side of communication, gNB2 110-2 may receive 218 the HO request message 202, which may include second information on the candidate relay UE for the second indirect path and may or may not include the first information to indicate the path switch to the candidate relay UE, as mentioned above.

gNB2 110-2 may transmit 224 a RRCReconfiguration message 204 to the candidate relay UE (i.e., UE2 120-2 as shown in FIG. 1B) directly, to reconfigure the candidate relay UE 120-2 for the coming path switch. In other words, RRCReconfiguration message 204 may also be referred as RRCReconfiguration for remote UE. On the other side of the communication, the candidate relay UE 120-2 may receive 226 the RRC reconfiguration message 204.

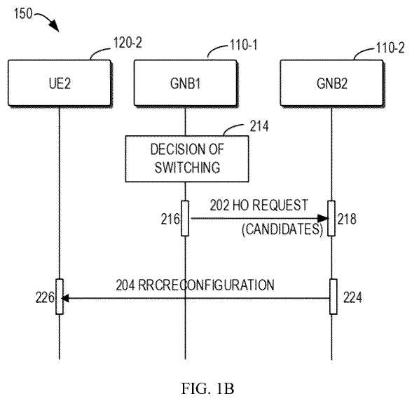

FIG. 2A illustrates an example signaling chart illustrating communication process 200 in accordance with some embodiments of the present disclosure. Only for the purpose of discussion, the process 200 will be described with reference to FIGS. 1A and 1B. The process 200 may involve gNB 110. More specifically, the process 200 may involve a source gNB 110-1 shown as gNB1 and a target gNB 110-2 shown as gNB2.

gNB1 110-1 may transmit 216 a handover (HO) request message 202 to gNB2 110-2, and the HO request message may include the first information to indicate the path switch to the candidate relay UE (for example, UE2 120-2 as illustrated in FIG. 1B) for the second indirect path and the second information on the candidate relay UE. On the other side of communication, gNB2 110-2 may receive 218 the HO request message 202.

In response to receipt of the HO request message 202, gNB2 110-2 may send 220 a HO acknowledgement (ACK) message 203 to gNB1 110-1, and the HO ACK message 203 may include a HO command for the UE1 120-1. More specifically, in some examples, the HO ACK message 203 may be a HO request ACK message. On the other side of communication, gNB1 110-1 may receive 222 from gNB2 110-2 the HO ACK message 203 including the HO command for the UE1 120-1.

FIG. 2B illustrates a signaling chart illustrating communication process 250 in accordance with some embodiments of the present disclosure. Only for the purpose of discussion, the process 250 will be described with reference to FIG. 1. The process 250 may involve UE 120 and gNB 110.

In some embodiments of the present disclosure, at first, gNB1 110-1 and UE1 120-1 communicate with direct links. gNB1 110-1 may configure UE1 120-1 to measure candidate terminal devices for coming path switch. In response to such measurement configurations, UE1 120-1 may measure candidate terminal devices and send 210 measure report 201 to gNB1 110-1, on a periodic or event-triggered basis, for example, based on threshold values defined in the measurement configurations. In the measure report 201, L2 ID (for example, source identity or L2 source identity, and it is of 24 bits or 32 bits), serving cell ID (for example, a cell global identifier (CGI), or a NR cell global identifier (NCGI)) and measure results (like RSRP) of the candidate relay UEs may be included. L2 ID of the UE1 120-1 itself may also be included in the measurement report 201.

On the other side of communication, gNB1 110-1 may receive 212 the measure report 201, which is sent 210 from the terminal device 120-1. Then the network device 110-1 may determine 214, based on the received measure report 201, a path switch for the UE1 120-1 from a first path including gNB1 110-1 to a second indirect path including gNB2 110-2.

Upon determination of the path switch, gNB1 110-1 may further transmit 216 a handover (HO) request message 202 to gNB2 110-2, and the HO request message may include second information on the candidate relay UE for the second indirect path. There may be one or more candidate relay UE; the numbers of candidate relay UE are only for illustrative purposes without suggesting any limitation.

In some embodiments of the present disclosure, the second information comprises at least one of: an identifier (ID) of the candidate relay UE, cell information of the candidate relay UE, and a measurement result for the candidate relay UE.

For example, the number of the candidate relay UE may be just one. In this case, the second information on the candidate relay UE may comprise at least one of: an identifier (ID) of the candidate relay UE, cell information of the candidate relay UE, and a measurement result for the candidate relay UE. Such information may be derived from the measurement report received by the gNB1 110-1 from UE 120-1. For example, in the example as illustrated in FIG. 1A, if UE2 120-2 is the only candidate relay UE1, the second information on the candidate relay UE may comprise one or more of the ID, cell ID and measurement result of UE 120-2.

In some embodiments of the present disclosure, the second information on the candidate relay UE may comprise at least one of: a list of IDs of a plurality of candidate relay UEs including the candidate relay UE, a list of serving cells of the plurality of candidate relay UEs, a list of radio resource control (RRC) contexts of the plurality of candidate relay UEs, and a list of measurement results for the plurality of candidate relay UEs.

For example, there may be multiple candidate relay UEs. For example, in the example as illustrated in FIG. 1A, if there is other candidate relay UE other than UE2 120-2, the second information on the candidate relay UE may comprise a list of IDs, including the ID of UE 120-2, and the ID of other candidate relay UE. Alternatively or additionally, the second information on the candidate relay UE may comprise lists of serving cells of the plurality of candidate relay UEs, including the serving cell of UE2 120-2, and the serving cell of other candidate relay UE. Alternatively or additionally, the information may comprise a list of RRC contexts of the plurality of candidate relay UEs, including the RRC contexts of UE2 120-2, and the RRC contexts of other candidate relay UE. Alternatively or additionally, the information may comprise a list of measurement results for the plurality of candidate relay UE, including the measurement results of UE 120-2, and the measurement results of other candidate relay UE. The second information on the candidate relay UE may comprise any combinations of such lists.

In this way, preparation of target relay UE can be enabled, and more suitable Relay UE(s) can be selected since multiple candidates are provided along with their corresponding measurement results.

In some embodiments of the present disclosure, at least one of the followings are met: the plurality of candidate relay UEs belong to a same target cell indicated by the cell information, the cell information indicates at least one serving cell corresponding to each of the plurality of candidate relay UEs, an order of the plurality of candidate relay UEs is based on the plurality of measurement results, an order of the lists of serving cells is based on the order of the plurality of candidate relay UEs, an order of the RRC contexts is based on the order of the plurality of candidate relay UEs, and an order of the lists of measurement results is based on the order of the plurality of candidate relay UEs. Here, “target cell” refers to a cell on which the candidate relay UE may camp. In other words, the “target cell” may be the suitable cell, or the selected cell, or the serving cell of the candidate UE.

For example, there are multiple candidate relay UEs, and the multiple candidate relay UEs may belong to a same target cell indicated by the cell information, and the cell information may be included in the list of serving cells mentioned above. Alternatively or additionally, the cell information indicates at least one serving cell corresponding to each of the multiple candidate relay UEs. Alternatively or additionally, the order of the multiple candidate relay UEs is based or sorted on the multiple measurement results. For example, one relay UE of the multiple candidate relay UEs with the highest measurement result (e.g. RSRP) is list first. Alternatively or additionally, the order of the lists of serving cells is based on the order of the multiple candidate relay UEs. Alternatively or additionally, the order of the RRC contexts is based on the order of the multiple candidate relay UEs. Alternatively or additionally, the order of the lists of measurement results is based on the order of the multiple candidate relay UEs. Alternatively or additionally, any combination of such conditions may be present.

In this way, the preparation of target Relay UE can be enabled, and finer configuration can be made based on the source relay UE's RRC context.

In some embodiments of the present disclosure, the first information may comprise a cause value and the cause value may be newly-defined as at least one of: SL path switch, SL path switch to relay UE, SL path switch from a gNB to a relay UE, SL path switch from relay to another relay UE, SL path switch for I2I, and SL path switch for D2I. Here, “SL” is short for “sidelink”, “I2I” refers to a situation where UE 120-1 switches from an indirect path involving a first gNB to another indirect path involving a second gNB which is different from the first gNB, and “D2I” refers to a situation where UE 120-1 switches from a direct path involving a first gNB to an indirect path involving a second gNB which is different from the first gNB. In this way, the cause value “SL path switch” may simply indicate that the handover request message is for the UE 120-1 to perform a sidelink path switch. The cause value “SL path switch to relay UE” may indicate that the handover request message is for the UE 120-1 to perform a sidelink path switch to a relay UE (such as UE 120-3). The cause value “SL path switch from a gNB to a relay UE” may indicate that the handover request message is for the UE 120-1, which communicates with gNB 110-1 with direct channels, to perform a sidelink path switch to communicate with gNB 110-1 via a relay UE (such as UE 120-3). The cause value “SL path switch from relay to another relay UE” may indicate that the handover request message is for the UE 120-1, which communicates with gNB 110-1 with indirect channels via a relay (not shown in FIG. 1), to perform a sidelink path switch to communicate with gNB 110-1 via another relay UE (such as UE 120-3 as shown in FIG. 1). The cause value “SL path switch for I2I” may indicate that the handover request message is for the UE 120-1, which communicates with gNB 110-1 with indirect channels via a relay UE (such as UE 120-3 as illustrated in FIG. 1), to perform a sidelink path switch to communicate with gNB 110-2 via a relay UE (such as UE 120-2). The cause value “SL path switch for D2I” may indicate that the handover request message is for the UE 120-1, which communicates with gNB 110-1 with direct channels, to perform a sidelink path switch to communicate with gNB 110-2 via a relay UE (such as UE 120-2).

In one example, if UE1 120-1 first communicates with gNB1 110-1 with direct links, then switches to communicate with gNB2 110-2 with indirect links via a relay UE 120-2, the cause value may be set as “SL path switch for D2I”. In another example, if the UE 120-1 first communicates with gNB1 110-1 with indirect links (for example, via a relay UE 120-3), then switches to communicate with gNB2 110-2 with indirect links via a relay UE 120-2, the cause value may be set as “SL path switch for I2I”.

In another example, if the cause value is set as “SL path switch to relay UE”, those optional information for candidate relay UE (for example, UE2 120-2 as illustrated in FIG. 2B), such as a set of target relay UE IDs, measurement result for each target relay UE, the serving cell corresponding to each target relay UE, are presented and the target gNB (for example, gNB2 110-2 as illustrated in FIG. 2B) prepares target relay UE based on those information.

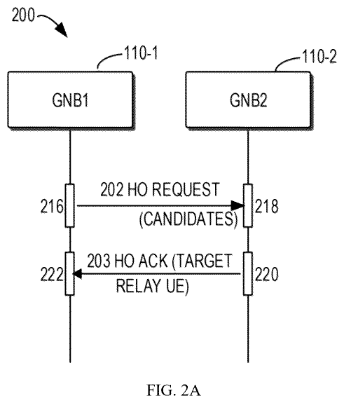

In another example, if the cause value is set as “SL path switch for D2I”, those optional information for target relay UE (for example, UE2 120-2 as illustrated in FIG. 2B), such as a set of target relay UE IDs, measurement result for each target relay UE, the serving cell corresponding to each target relay UE, are presented. Else, if the cause value is set as “SL path switch for I2I”, those optional information for source relay UE (for example, UE3 120-3 as illustrated in FIG. 3) and target relay UE (for example, UE2 120-2 as illustrated in FIG. 2B), such as a set of target relay UE IDs, measurement result for each target relay UE, the serving cell corresponding to each target relay UE, RRC context of source relay UE are presented.

In some embodiments of the present disclosure, in order to transmit the HO request message, gNB1 110-1 may transmit a plurality of handover request messages to the second network device 110-2, where the handover request message is one of the plurality of handover request messages for the terminal device 120-1, and a first one of the plurality of handover request messages includes a UE context of the terminal device 120-1.

For example, in order to transmit the HO request message, gNB1 110-1 may transmit a plurality of HO request messages to gNB2 110-2, and one of the plurality of HO request messages may include a UE context of the UE1 120-1. In other words, the UE context of the UE1 120-1 only need to be transmitted once by the plurality of HO request messages to gNB2 110-2.

In some example embodiments, the UE 120-1 may further send the ID of the candidate relay UE to its serving network device, namely, the network device 110-1. On the other side of the communication, the network device 110-1 may receive the ID of the candidate relay UE from the UE 120-1.

In some example embodiments, the ID of the candidate relay UE is received via at least one of a measurement report and assistance information. In one example, the UE 120-1 may report L2 ID or Uu ID or core network ID or a combination of above mentioned IDs of the candidate relay UE to its serving network device 110-1, namely, the network device 110-1 via a measurement report. On the other side of the communication, the network device 110-1 may receive the ID of the candidate relay UE 120-2 via the received measurement report. In another example, the UE 120-1 may report Uu ID or core network ID of the candidate relay UE to its serving network device 110-1, namely, the network device 110-1 via assistance information(for example, UE Assistance Information(UAI), Sidelink UE Information(SUI)). On the other side of the communication, the network device 110-1 may receive the ID of the candidate relay UE 120-2 via the received assistance information.

In this way, the target gNB (for example, gNB2 110-2 as illustrated in FIG. 2B) can identify the target relay UE (for example, UE2 120-2 as illustrated in FIG. 2B).

In some example embodiments, the network device 110-1 may further transmit, to a neighbor network device, a first Xn message including at least an L2 ID and a serving cell ID of the candidate relay UE. In on example, it may include only the L2 ID of the candidate relay UE. In another example, it may include the L2 ID and the serving cell ID of the candidate relay UE. And the network device 110-1 may further receive, from the neighbor network device, a second Xn message including the L2 ID and a Uu ID or a core network device ID of the candidate relay UE. Here, “serving cell” refers to a cell on which the relay UE may camp. In other words, the “serving cell” may be the suitable cell, or the selected cell, or the serving cell of the candidate UE.

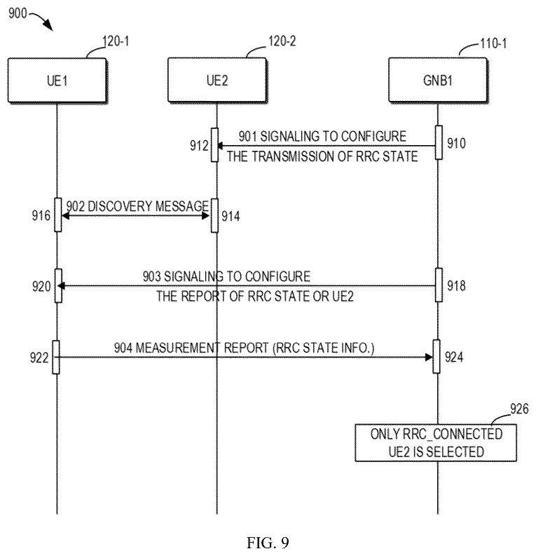

In one example illustrated in FIG. 11, which illustrates a signaling chart illustrating communication process 1100 in accordance with some embodiments of the present disclosure, process 1100 may involve the UEs 120-1 and 120-2, the network devices 110-1 and a neighbor network device 110-4. Only for the purpose of discussion, the process 1100 will be described with reference to FIGS. 1A and 2B. As illustrated in FIG. 11, the network device 110-1 may transmit 1118, to a neighbor network device 110-4, a first Xn message (such as a Xn request message) 1103 including an L2 ID and a serving cell ID of the candidate relay UE 120-2, to request for Uu ID and/or core network ID of the candidate relay UE 120-2. On the other side of the communication, the neighbor network device 110-4 may receive the Xn message 1103. The neighbor network device 1104 may analyze and process the Xn message 1103, and then send 1122 a second Xn message (such as a Xn acknowledge message) 1104 including the L2 ID, a Uu ID or a core network ID of the candidate relay UE 120-2 back to the network device 110-1. On the other side of the communication, the network device 110-1 receives 1124 the Xn acknowledge message 1104. Additionally, the first Xn message may include an L2 ID and a serving cell ID of any UE, rather than the relay UE 120-2, to request for a Uu ID and/or a core network ID of it. As another example, the first Xn message may indicate the neighbor network device 1104 to feed back a third information about all relay UEs or UEs served by it, wherein the third information may include at least one of an L2 ID, a Uu ID, a core network ID and a serving cell ID for each relay. Additionally and alternatively, the first Xn message may include the second information of relay UEs served by it, wherein the second information include at least of an L2 ID, a Uu ID, a core network ID and a serving cell ID for each relay UE.

In some example embodiments of the present disclosure, gNB1 110-1 may provide L2 ID of candidate relay UE (in this example, UE2 120-2 as illustrated in FIG. 2B) and its serving cell (e.g. NCGI) to request its Uu ID or Core network ID via Xn message whose message type may be “SL Information Request”. The neighbor gNB 1104 may reply this message with L2 ID and Uu ID/Core network ID via Xn message whose message type may be “SL Information Acknowledge”. Additionally, these two types of Xn messages may include information about multiple relay UEs as well as UE1 120-1 who may experience the path switch. This procedure may be triggered periodically, or triggered by measurement report form UE1 120-1.

In some example embodiments, the first Xn message may be a sidelink information request, and the second Xn message may be a sidelink information acknowledgement. The first Xn message may include information on a plurality of candidate relay UEs, and the second Xn message may include information on the plurality of candidate relay UEs. The first Xn message may be triggered periodically or triggered by a measurement report from the UE 120-1. The first Xn message may further request a RRC state of the candidate relay UE 120-2, and the second Xn message may further include a RRC state of the candidate relay UE 120-2. The first Xn message may further request a latest serving cell of the candidate relay UE 120-2, and the second Xn message may further include a latest serving cell of the candidate relay UE 120-2.

In some example embodiments, the network device 110-1 may receive, from the neighbor network device 110-4, a third Xn message including the L2 ID and a Uu ID or a core network device ID of the candidate relay UE; and transmit, to a neighbor network device 110-4, a fourth Xn message as an acknowledgement to the third Xn message.

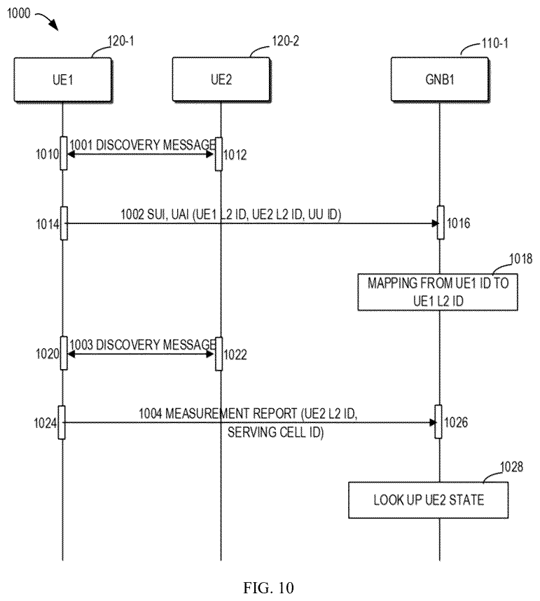

In one example illustrated in FIG. 12, which illustrates a signaling chart illustrating communication process 1200 in accordance with some embodiments of the present disclosure, the process 1200 may involve the UEs 120-1 and 120-2, the network devices 110-1 and a neighbor network device 110-4. Only for the purpose of discussion, the process 1200 will be described with reference to FIGS. 1A and 2B. The neighbor network device 110-4 may transmit 1210, to the network device 110-1, a third Xn message (such as a Xn announce message) 1201 including at least one of the L2 ID, a serving cell, a Uu ID or a core network device ID of the candidate relay UE (i.e., the UE 120-2). In one example it may include the L2 ID and a Uu ID of the candidate relay UE. In another example, it may include a Uu ID and the serving cell ID of the candidate relay UE. On the other side of the communication, the network device 110-1 may receive 1212, from the neighbor network device 110-4, the third Xn message (such as a Xn announce message) 1201 including the L2 ID and a Uu ID or a core network device ID of the candidate relay UE 120-2. Further, in response to receipt of the third Xn message 1201, the network device 110-1 may transmit 1214, to the neighbor network device 110-4, a fourth Xn message 1202 (such as a Xn acknowledgement message) as an acknowledgement to the third Xn message. On the other side of the communication, the neighbor network device 110-4 may receive 1216 from the network device 110-1 the fourth Xn message 1202 as an acknowledgement to the third Xn message. Additionally and alternatively, the fourth Xn message may include the forth information of relay UEs served by the network device 110-1, wherein the second information include at least of an L2 ID, a Uu ID, a core network ID and a serving cell ID for each relay UE. Additionally and alternatively, the fourth Xn message may not be sent by the network device 110-1. In other words, the third Xn message may not have an acknowledgement message corresponding to it.

In some example embodiments, the third Xn message may be a sidelink information announcement. In this case, the neighbor network device 110-4 may transmit the L2 ID, serving cell ID, Uu ID and/or core network ID of the candidate relay UE 120-2 to the network device 110-1 via the third Xn message for sidelink information announcement. Alternatively or additionally, the third Xn message may include information on a plurality of candidate relay UEs. For example, when there are more than one candidate relay UE available, the third Xn message may include information on the plurality of candidate relay UEs. Alternatively or additionally, the fourth Xn message may include information on the plurality of candidate relay UEs. Alternatively or additionally, the third Xn message may further announce a RRC state of the candidate relay UE 120-2. Alternatively or additionally, the third Xn message may further announce a latest serving cell of the candidate relay UE 120-2.

On the other side of communication, gNB2 110-2 may receive 218 the HO request message 202. In response to receipt of the HO request message 202, gNB2 110-2 may send 220 a HO acknowledgement (ACK) message 203 to gNB1 110-1, and the HO ACK message 203 may include a HO command for the UE1 120-1. More specifically, in some examples, the HO ACK message 203 may be a HO request ACK message.

In some examples, as illustrated in FIG. 12, the neighbor gNB 1104 is a neighbor of gNB1 110-1, and gNB1 110-1 is also a neighbor of the neighbor gNB 1104. The neighbor gNB 1104 may announce L2 ID and Uu ID/Core network ID of UE1 120-1 and/or candidate relay UE (for example, UE2 120-2 as illustrated in FIG. 2B) and its serving cell via Xn message to gNB1 110-1, namely, a neighbor of the neighbor gNB 1104. In this case, the message type of the Xn message may be “SL Information Announce”. Optionally, gNB1 110-1 may reply the received Xn message with a Xn ACK message. Additionally, the Xn message may include information about multiple candidate relay UEs as well as UE1 120-1. It is to be understood that the Xn massage can also be used to request/announce other relay UE related information such as the RRC state of relay UE, the latest serving cell of relay UE.

In some example embodiments, gNB1 110-1 may receive from the second network device a HO ACK message including the HO command for the terminal device. For example, gNB1 110-1 may receive 222 from gNB2 110-2 the HO ACK message 203 including the HO command for the UE1 120-1.

In some embodiments of the present disclosure, the HO ACK message may comprise at least one of: a Layer 2 (L2) ID of a selected relay UE, information on a serving cell of the selected relay UE, a local ID of the terminal device, a PC5 Relay radio link control (RLC) channel configuration for a relay traffic, information on an end-to-end radio bearer, and a plurality of IDs of a set of selected relay UEs. Hereafter, “a selected relay UE” may also be referred to as “a target relay UE”, which means the relay UE via which UE 120-1 may communicate with the target network device after the path switch, where the “target network device” refers to the network device serving UE 120-1 after the path switch.

For example, as illustrated in FIG. 2B, UE 120-2 is selected or prepared bygNB2 110-2 as the relay UE for UE1 120-1 to communicate with gNB2 110-2. Alternatively, UE 120-2 is selected by gNB1 110-1 as the relay UE for UE1 120-1 to communicate with gNB2 110-2. In such a case, the HO ACK message may comprise Layer 2 (L2) ID of UE2 120-2. Alternatively or additionally, the HO ACK message may comprise information on a serving cell of UE2 120-2. Alternatively or additionally, the HO ACK message may comprise a local ID of the UE1 120-1. Alternatively or additionally, the HO ACK message may comprise a PC5 Relay RLC channel configuration for a relay traffic, such as a PC5 Relay RLC channel configuration for a relay traffic from/to the selected relay UE (i.e., the UE 120-2 as illustrated in FIG. 2B). Alternatively or additionally, the HO ACK message may comprise information on an end-to-end radio bearer. Alternatively or additionally, the HO ACK message may comprise a plurality of IDs of a set of selected relay UEs, which means, gNB2 110-2 may select more than one relay UE for the path switch of the UE1 120-1.

In some embodiments of the present disclosure, when receiving the handover acknowledgement message from gNB2 110-2, the gNB1 110-1 may receive, from gNB2 110-2, a plurality of handover acknowledgement messages for a set of selected relay UEs, the handover acknowledgement message being one of the plurality of handover acknowledgement messages.

For example, as mentioned above, the HO ACK message may comprise a plurality of IDs of a set of selected relay UEs, which means, gNB2 110-2 may select or prepare more than one relay UE for the path switch of the UE1 120-1. As another example, for the set of selected or prepared relay UEs, gNB2 110-2 may send a plurality of handover acknowledgement messages to gNB1 110-1, and gNB1 110-1 may receive the plurality of handover acknowledgement messages accordingly.

In some embodiments of the present disclosure, in response to expiry of a timer for receiving a handover feedback message from the second network device, determining a failure of the path switch.

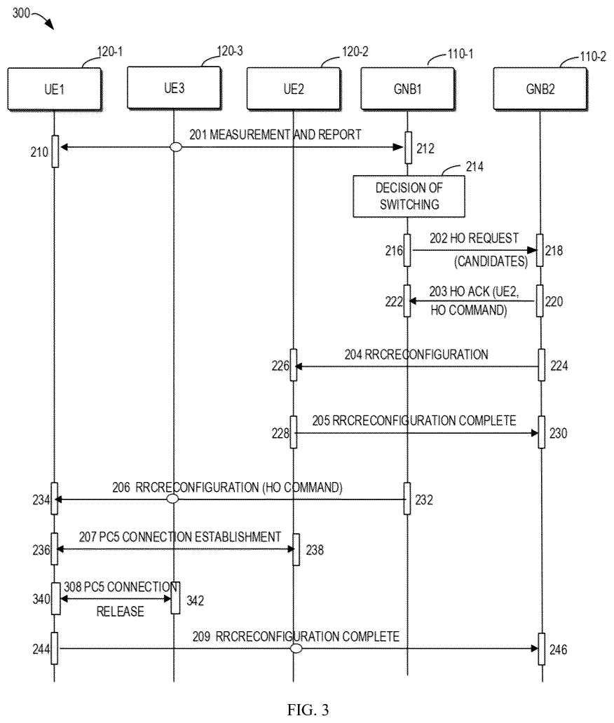

For example, as illustrated in FIG. 5A, which illustrates an example signaling chart illustrating communication process 500 in accordance with some embodiments of the present disclosure, after gNB1 110-1 sends 216 the HO request 202 to gNB2 110-2 but gNB 110-2 does not feedback any HO acknowledgement message 203 in response to the HO request 202 during the duration of a timer for receiving the HO acknowledgement message 203, gNB1 110-1 may determine a failure (for example, a “timeout” failure) of the path switch. In some examples, the timer for receiving the HO acknowledgement message 203 is a TXnRELOCprep timer as legacy. In some other examples, the timer for receiving the HO acknowledgement message 203 is a new timer specific for path switch or specific for path switch to relay UE.

In some embodiments of the present disclosure, gNB2 110-2 may transmit a HO preparation failure message associated with the candidate relay UE to gNB1 110-1, and on the other side of communication, gNB1 110-1 may receive from gNB2 110-2 the HO preparation failure message associated with the candidate relay UE. In some other embodiments of the present disclosure, gNB2 110-2 may transmit a HO preparation failure message including a cell ID to gNB1 110-1 to indicate the preparation failure of a plurality of relay UEs served by the cell indicated by the cell ID and the cell ID or the plurality of relay UEs ID is send in HO request (for example, HO request 202 in FIG. 5B). Additionally, an indication for the failure of preparation for a plurality of relay UEs is send together with the cell ID.

For example, as illustrated in FIG. 5B, which illustrates another signaling chart illustrating communication process 550 in accordance with some embodiments of the present disclosure, after sending 216 the HO request 202 to the network device 110-2, gNB2 sends 560 a HO preparation failure message 505 to gNB1. On the other side of communication, gNB1 110-1 receives 562 the HO preparation failure message 505 associated with the candidate UE from gNB2 110-2. And the cell ID and the plurality of relay UEs is requested in HO request 202.

In some embodiments of the present disclosure, the handover preparation failure message includes at least one of: a cause value indicating a reason of the handover preparation failure, and an ID of the candidate relay UE.

For example illustrated in FIGS. 2 and 5, the candidate UE is UE 120-2, the HO preparation failure message may include a cause value indicating a reason of the HO preparation failure. Alternatively or additionally, the HO preparation failure message may include an ID of UE2 120-2. Alternatively or additionally, the HO preparation failure message may include both the cause value and the ID of UE2 120-2.

In some embodiments of the present disclosure, the reason may be at least one of: no radio resource available in the candidate relay UE, a change of a serving cell for the candidate relay UE, the candidate relay UE being unavailable, an ID of the candidate relay UE being unknown to the second network device, the candidate relay UE not allowing the path switch, and the candidate relay UE not supporting a 5QI value of the second indirect path.

For example illustrated in FIGS. 2 and 5, the candidate UE is UE 120-2, the reason included in the HO preparation failure message 505 may be at least one of:
there is no radio resource available in the candidate relay UE (i.e., UE 120-2),
there is a change of a serving cell for the candidate relay UE (i.e., UE 120-2),
the candidate relay UE (i.e., UE 120-2) is unavailable,
the ID of the candidate relay UE (i.e., UE 120-2) is unknown to gNB2 110-2,
the candidate relay UE (i.e., UE 120-2) does not allow the path switch, and
the candidate relay UE (i.e., UE 120-2) does not support a 5QI value of the second indirect path (the connection link between UE1 120-1 and gNB2 110-2 via UE2 120-2).

Then, the network device 110-2 may send 560 the HO preparation failure message 505 associated with the candidate relay UE 120-2 to the network device 110-1. On the other side of communication, the network device 110-1 may receive 562 the HO preparation failure message 505 associated with the candidate relay UE 120-2 from the network device 110-2.

In some embodiments of the present disclosure, in response to receiving the handover preparation failure message, gNB1 110-1 may further transmit a further handover request message to the second network device, the further handover request message including third information on a further candidate relay UE for the second indirect path.

For example, in response to receiving 562 the HO preparation failure message 505, gNB1 110-1 may further transmit a further HO request message to gNB2, and the further HO request message may include third information on a further candidate relay UE for the second indirect path.

In some embodiments of the present disclosure, prior to receiving a HO ACK message from gNB2 110-2, gNB1 110-1 may, in response to determining to cancel the path switch, transmit a handover cancel message to the second network device.

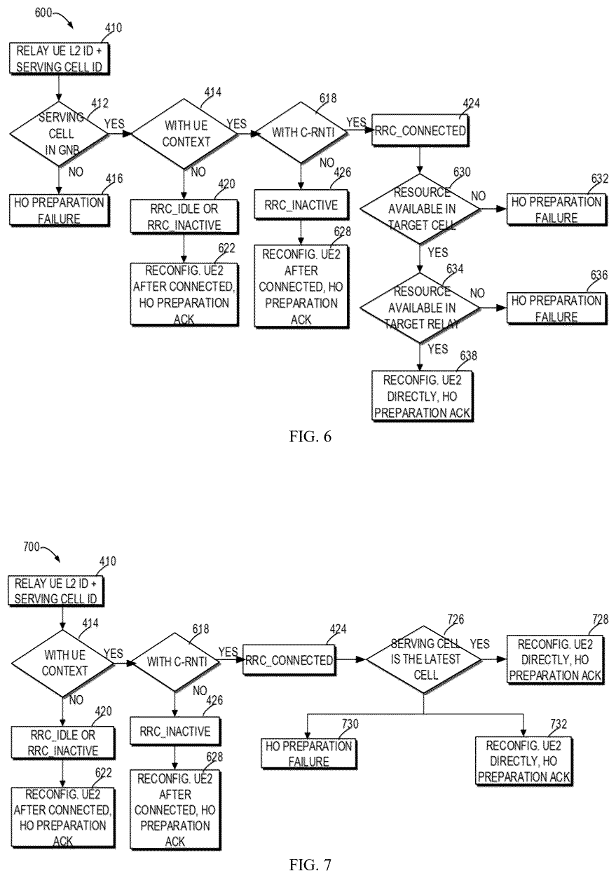

For example, FIG. 8A illustrates a signaling chart illustrating communication process 800 in accordance with some embodiments of the present disclosure. The process 800 may involve the UE 120-1 and gNB1 110-1 and gNB2 110-2. FIG. 8B illustrates a signaling chart illustrating communication process 880 in accordance with some embodiments of the present disclosure. The process 880 may involve gNB1 110-1 and gNB2 110-2 and another gNB (denoted as gNB3) 110-3 which creates the latest serving cell of the candidate relay UE 120-2 after the serving cell of the UE 120-2 changed from the original serving cell created by gNB2 110-2. In other words, the latest serving cell may also be referred to as the target cell. FIG. 8C illustrates a signaling chart illustrating communication process 890 in accordance with some embodiments of the present disclosure. The process 890 may involve gNB1 110-1 and gNB2 110-2. Only for the purpose of discussion, the process 890 will be described with reference to FIGS. 1A and 2B.

For example, as illustrated in FIGS. 8A, 8B and 8C, gNB1 110-1 may determine to cancel the path switch and then transmit 818 a HO cancel message 803 to gNB2 110-2 in response to determining to cancel the path switch.

In some embodiments of the present disclosure, the handover cancel message includes at least one of: a value indicating a cancel of HO request or HO preparation of a relay UE, a value indicating that a target cell of the candidate relay UE is unknown to the first network device, a value indicating a change of a serving cell of the candidate relay UE, an ID of the candidate relay UE, a cell ID and a plurality of IDs of a set of candidate relay UEs.

In one example, the HO cancel message 803 may include a value indicating that a target cell (for example, cell 102) of the candidate relay UE (i.e., the UE 120-2) is unknown to gNB1 110-1. In another example, the HO cancel message 803 may include a value indicating a change of a serving cell of the candidate relay UE (i.e., the UE 120-2). In another example, the HO cancel message 803 may include an ID of the candidate relay UE (i.e., the UE 120-2), as illustrated in FIGS. 8A, 8B and 8C. In another example, the HO cancel message 803 may include a plurality of IDs of a set of candidate relay UEs (for example, when information on a plurality of candidate UEs is transmitted from gNB1 110-1 to gNB2 110-2 in the HO request 202, as illustrated in FIG. 2B). In another example, the HO cancel message 803 may include a cell ID to request the cancel of a plurality of candidate UE served by it.

In some embodiments of the present disclosure, the gNB1 110-11 may further determine the change of the serving cell of the candidate relay UE based on receiving at least one of: an explicit indication of the change of the serving cell of the candidate relay UE, and an implicit indication of a latest serving cell of the candidate relay UE different from a serving cell of the candidate relay UE in the handover request message.

For example, gNB1 110-1 may further determine the change of the serving cell of the candidate relay UE (i.e., the UE 120-2) based on receiving an explicit indication of the change of the serving cell of UE 120-2, and an implicit indication of a latest serving cell of the candidate relay UE different from a serving cell of the candidate relay UE in the handover request message. In one example as illustrated in FIG. 8B, an implicit indication of a latest serving cell of the candidate relay UE (i.e., UE 120-2) different from a serving cell of the candidate relay UE in the handover request message may be sent 834 from the network device 110-3 associated with the latest serving cell of UE 120-2 to the network device 110-1 via Xn message 805. The network device 110-1 may receive 836 this Xn message 805, and may determine the change of the serving cell of the UE 120-2 based on receipt of this Xn message 805 comprising the implicit indication. In another example as illustrated in FIG. 8C, an explicit indication of the change of the serving cell of the candidate relay UE (i.e., UE 120-2) may be sent 854 from the network device 110-2 to the network device 110-1 via Xn message 808. The network device 110-1 may receive 836 this Xn message 808, and may determine the change of the serving cell of the UE 120-2 based on receipt of this Xn message 808 comprising the explicit indication.

In some example embodiments, at least one of the explicit indication and the implicit indication is received via at least one of: a report from the terminal device, a notification from a latest serving network device of the candidate relay UE; and a notification from a target network device of the terminal device. Here, “target network device” refers to a network device serving the terminal device after path switch.

In one example as illustrated in FIG. 8A, the at least one of the explicit indication and the implicit indication is received 816 via a report (RRC message 802) from the UE 120-1. In another example as illustrated in FIG. 8B, the at least one of the explicit indication and the implicit indication is received 836 by the network device 110-1 via Xn interface from a latest serving network device 110-3 of the candidate relay UE 120-2 in a Xn message 805. In another example as illustrated in FIG. 8C, the at least one of the explicit indication and the implicit indication is received 856 by the network device 110-1 via Xn interface from network device 110-2 (which is the target network device for the candidate relay UE 120-2) in a Xn message 808.

In this way, the handling of HO cancel for target relay UE can be enabled.

In some example embodiments, an information element (IE) of a target cell ID in the handover cancel message is one of: mandatorily present, optionally present, and mandatorily present but ignored if a cause value of the handover cancel message is set to indicate a reason of a cancel associated with the candidate relay UE. In one example, the target cell ID may be kept as mandatorily present in the HO cancel message 803. In another example, in the HO cancel message 803, target cell ID changed may be optionally present. In another example, in the HO cancel message 803, the target cell ID may be kept as mandatorily present, but may be ignored if case value of the HO cancel message is set to indicate a reason of a cancel associated with the candidate relay UE.

In some example embodiments, the HO cancel message is a custom Xn message. For example, a new Xn message may be defined to include elements of the conventional HO cancel message as well as a list of candidate relay UE to be cancelled.

In some example embodiments, the ID of the candidate relay UE comprises at least one of: an integer multiple of 8 bits, an L2 ID reported by the terminal device, a Uu ID, a core network ID, and a combination of the L2 ID and the Uu ID or the core network ID. For example, UE 120-2 is the candidate relay UE, the ID of the candidate relay UE, namely, the UE 120-2 may be an integer multiple of 8 bits, and the ID of UE 120-2 may comprise this integer. Alternatively or additionally, the ID of the UE 120-2 may be an L2 ID reported by the UE 120-1, and the ID of UE 120-2 may comprise this L2 ID. Alternatively or additionally, the ID of the UE 120-2 may be a Uu ID, such as C-RNTI, I-RNTI or 5G-S-TMSI, and the ID of UE 120-2 may comprise this Uu ID. Alternatively or additionally, the ID of the UE 120-2 may be a core network ID, such as NG-RAN node UE XnAP ID, NG-C UE associated signaling reference, Signaling TNL association address at source NG-C side, and the ID of UE 120-2 may comprise this core network ID. Alternatively or additionally, the ID of the UE 120-2 may be a combination of the L2 ID and the Uu ID or the core network ID, and the ID of UE 120-2 may comprise this combination. Alternatively or additionally, the ID of the UE 120-2 may be any combination of the IDs listed above in this paragraph.

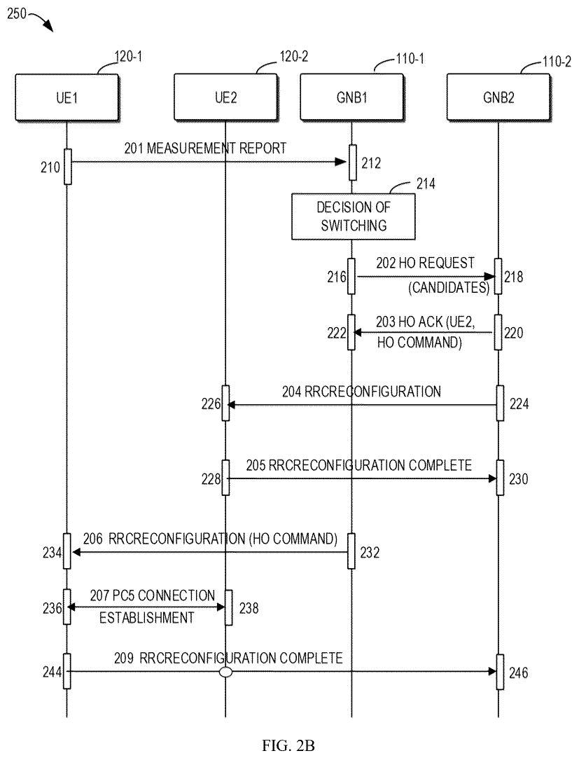

FIG. 4 illustrates a flow chart of an example method 400 implemented at the target network device in accordance with some embodiments of the present disclosure. Only for the purpose of discussion, the process 400 will be described with reference to FIGS. 1A and 2B. The process 400 may involve the network devices 110-2.

In some example embodiments, the network device 110-2 may, in response to determining that a serving cell of the candidate relay UE is not managed by the second network device, transmit a HO preparation failure message to the network device 110-1.

For example, as illustrated in FIG. 4, when the L2 ID and serving cell ID of the candidate relay UE (such as the UE 120-2) is acquired 410, for example, from the network device 110-1 via the HO request 202, the network device 110-2 may determine 412 whether the serving cell of the UE 120-2 is in the coverage area of the network device 110-2 or not. If the network device 110-2 determines that a serving cell of the candidate relay UE 120-2 is not managed by the network device 110-2 itself, the network device 110-2 may transmit a HO preparation failure message to the network device 110-1. On the other side of the communication, the network device 110-1 may receive the HO preparation failure message from the network device 110-1, as also illustrated in FIG. 5B, which will be described later.

In some example embodiments, the network device 110-2 may, in response to determining that a UE context of the candidate relay UE is found and the candidate relay UE is in an RRC_CONNECTED state, transmit the RRC reconfiguration message directly.

For example, as illustrated in FIG. 4, if the network device 110-2 determines 412 that a serving cell of the candidate relay UE 120-2 is managed by the network device 110-2 itself (yes), the network device 110-2 may further determine whether there is UE context for the candidate relay UE 120-2 available. If yes, the network device 120-2 further determines whether a Uu ID (such as an I-RNTI) of the candidate relay UE 120-2 is available. If not available, the network device 110-2 may determine that the candidate relay UE 120-2 is in an RRC_CONNECTED state, thus the network device 110-2 may transmit the RRC reconfiguration message to the UE 120-2 directly, as also illustrated in FIG. 1A, the network device 110-2 transmit 224 the RRC reconfiguration message 204 directly to the relay UE 120-2. On the other side of the communication, the relay UE 120-2 may receive 226 the RRC reconfiguration message 204.

In some example embodiments, the network device 110-2 may, in response to determining that the UE context is found and the candidate relay UE is in an RRC_INACTIVE state, transmit the RRC reconfiguration message after the candidate relay UE enters the RRC_CONNECTED state.

For example, as illustrated in FIG. 4, if the network device 120-2 further determines whether a Uu ID (such as an I-RNTI) of the candidate relay UE 120-2 is available, the network device 110-2 may determine 426 that the candidate relay UE 120-2 is in an RRC_INACTIVE state, thus the network device 110-2 may transmit 428 the RRC reconfiguration message after the candidate relay UE 120-2 enters the RRC_CONNECTED state. For example, the network device 110-2 may first send a RRC resume message to the candidate relay UE 120-2 to bring the UE 120-2 into RRC_CONNECTED state, then transmit 428 the RRC reconfiguration message to the UE 120-2.

As also illustrated in FIG. 4, the network device 110-2 may, in response to determining that the candidate relay UE 120-2 is in an RRC_IDLE state, transmit the RRC reconfiguration message after the candidate relay UE 120-2 enters the RRC_CONNECTED state. For example, the network device 110-2 may first send a RRC setup message to the candidate relay UE 120-2 to bring the UE 120-2 into RRC_CONNECTED state, then transmit 422 the RRC reconfiguration message to the UE 120-2.

In some example embodiments, the network device 110-2 may, in response to determining that a serving cell of the candidate relay UE indicated in the handover request message is changed, but a latest serving cell of the candidate relay UE is still under control of the second network device, transmit a handover acknowledgement message to the first network device.

For example, if the HO request 202 as illustrated in FIG. 2B indicates that the serving cell of the candidate relay UE 120-2 is cell 102 which is managed by the network device 110-2, and the network device 110-2 determines that the serving cell of the candidate relay UE 120-2 has changed to another latest serving cell 103, but the latest serving cell 103 of the candidate relay UE 102-2 is also managed by the network device 110-2, then the network device 110-2 may transmit a HO acknowledgement message to the network device 110-1, as illustrated also in FIG. 2B. In FIG. 2B, the network device 110-2 transmit 220 the HO acknowledgement message 203 to the network device 110-1.

gNB2 110-2 may reconfigure the selected relay UE 120-2, for example, via a RRCReconfiguration message 204. In other words, gNB2 110-2 may send 224 a RRCReconfiguration message 204 to the selected relay UE 120-2, to reconfigure the selected relay UE 120-2. On the other side of communication, the selected relay UE 120-2 may receive 226 the RRCReconfiguration message 204 from gNB2 110-2.

In response to receipt of the RRCReconfiguration message 204, the selected relay UE 120-2 may send 228 a RRCReconfiguration complete message 205 back to gNB2 110-2. On the other side of communication, gNB2 110-2 may receive 230 the RRCReconfiguration complete message 205 from the selected relay UE 120-2.

In response to receiving 222 from gNB2 110-2 the HO ACK message 203 including the HO command for the UE1 120-1, gNB1 110-1 may send 232 a RRCReconfiguration message 206 with the HO command received from gNB2 110-2 to UE1 120-1 to reconfigure UE1 120-1 for the path switch. On the other side of communication, UE1 120-1 may receive 234 the RRCReconfiguration message 206 with the HO command.

Then, UE1 120-1 may establish 236 a PC5 connection 207 with UE2 120-2. On the other side of communication, UE2 120-2 may establish 238 the PC5 connection 207 with UE1 120-1.

In response to the PC5 connection 207 being established between UE1 120-1 and UE2 120-2, UE1 120-1 may send 244 a RRCReconfiguration complete message 209 to gNB2 110-2. On the other side of communication, gNB2 110-2 may receive 246 the RRCReconfiguration complete message 209 from UE1 120-1.

Reference is now made to FIG. 3, which illustrates another signaling chart illustrating communication process 300 in accordance with some embodiments of the present disclosure. Only for the purpose of discussion, the process 300 will be described with reference to FIGS. 1A and 2B. The process 300 may involve the terminal device 120 and the network device 110. FIG. 3 is different from FIG. 2B in that, before path switch, the UE 120-1 and the network device 110-1 communicate via indirect links; for example, the UE 120-1 and the network device 110-1 communicate via a relay UE 120-3, with which UE 120-1 has a PC5 connection established. In this case, relay UE 120-3 before path switch is also referred to as a “source relay UE”. For simplicity of description, only different points as compared with FIG. 2B will be described below.

In some embodiments of the present disclosure, the handover request message includes at least one of: a UE context of the source relay UE, an RRC context of the source relay UE, a radio resource management (RRM) configuration of the source relay UE, a local ID of the source relay UE, a temporary ID of the source relay UE, and an L2 ID of the source relay UE.

In the example illustrated in FIG. 3, UE3 120-3 is the source relay UE, via which the UE1 120-1 communicate with its serving gNB 110-1 before path switch. In this case, the handover request message 202 may include at least one of: a UE context(for example, UE context information) of the UE 120-3, an RRC context of the UE 120-3, a handover preparation information of the UE 120-3, a radio resource management (RRM) configuration of the UE 120-3, an L2 ID of the UE 120-3, a local ID of the UE 120-1, a temporary ID of the UE 120-1, and an L2 ID of the UE 120-1.

In some embodiments of the present disclosure, as mentioned above, the first path is a first indirect path. In this case, in order to determine the path switch, the first network device may, in response to determining that a serving relay UE in the first indirect path becomes worse than a first threshold and a candidate relay UE for the second indirect path becomes better than a second threshold, determining to perform the path switch.

For example, the UE 120-1 at first communicates with gNB1 110-1 with indirect links via a source relay UE 120-3. When the measured RSRP for the UE 120-3 becomes worse than a first threshold TH1 and the measured RSRP for a candidate UE (like UE 120-2) for the second indirect path is better than a second threshold TH2, gNB1 110-1 may determine the path switch accordingly. These RSRPs may be measured by the UE 120-1 and sent 210 to the network device 110-1 in the measurement report 201 as illustrated in FIG. 2B or FIG. 3. In this case, a new event (that a serving relay UE in the first indirect path becomes worse than a first threshold and a candidate relay UE for the second indirect path becomes better than a second threshold) may be defined to trigger a path switch in such a scenario.

The above-mentioned new information element for target relay UE(s) in HO request message 202 may be defined as below:

| | | IE type and | |
|---|---|---|---|
| IE/Group Name | Presence | reference | Semantics description |
| Message Type | M | 9.2.3.1 | |
| Source NG-RAN node UE XnAP ID reference | M | NG-RAN node UE | Allocated at the source NG-RAN node |
| | | XnAP ID | |
| | | 9.2.3.16 | |
| Cause | M | 9.2.3.2 | |
| Target Cell Global ID | M | 9.2.3.25 | Includes either an E-UTRA CGI or an NR CGI |
| GUAMI | M | 9.2.3.24 | |
| A list of target Relay UE IDs | O | | |
| A list of measurement results for each target | O | | |
| Relay UE | | | |
| A list of RRC contents of target Relay UE | O | OCTET STRING | |
| A list of [symbol] for each target Relay UE | O | | Cell Global ID |
| UE Context Information | | | |

[symbol]

indicates data missing or illegible when filed

Alternatively, the above-mentioned new information element for target relay UE(s) in HO request message 202 may also be defined as below:

| | | IE type and | |
|---|---|---|---|
| IE/Group Name | Presence | reference | Semantics description |
| Message Type | M | 9.2.3.1 | |
| Source NG-RAN node UE XnAP ID reference | M | NG-RAN node UE | Allocated at the source NG-RAN node |
| | | XnAP ID | |
| | | 9.2.3.16 | |
| Cause | M | 9.2.3.2 | |
| Target Cell Global ID | M | 9.2.3.25 | Includes either an E-UTRA CGI or an NR CGI |
| GUAMI | M | 9.2.3.24 | |
| Target Relay UE Information | | | |
| >A list of Target Relay UE IDs | O | | |
| >A list of measurement results for each Target | O | | |
| Relay UE | | | |
| >A list of RRC contents of target relay UE | O | | |
| >A list of [symbol] for each target Relay UE | O | | Cell Global ID |
| UE Context Information | | | |

[symbol]

indicates data missing or illegible when filed

As another alternative, the above-mentioned new information element for target relay UE(s) in HO request message 202 may also be defined as below:

| | | IE type and | |
|---|---|---|---|
| IE/Group Name | Presence | reference | Semantics description |
| Message Type | M | 9.2.3.1 | |
| Source NG-RAN node UE XnAP ID reference | M | NG-RAN node UE | Allocated at the source NG-RAN node |
| | | XnAP ID | |
| | | 9.2.3.16 | |
| Cause | M | 9.2.3.2 | |
| Target Cell Global ID | M | 9.2.3.25 | Includes either an E-UTRA CGI or an NR CGI |
| GUAMI | M | 9.2.3.24 | |
| A list of Target Relay UE Information | | | |
| >Target Relay UE ID | O | | |
| >measurement results for corresponding Target | O | | |
| Relay UE | | | |
| >RRC context of target relay UE | O | | |
| >serving cell | O | | Cell Global ID |
| UE Context Information | | | |

The above-mentioned new information element for target relay UE(s) in HO acknowledgement message (which may also be referred to as “HO request acknowledgement message”) 203 may be defined as below:

| | | IE type and | |
|---|---|---|---|
| IE/Group Name | Presence | reference | Semantics description |
| Message Type | M | 9.2.3.1 | |
| Source NG-RAN node UE XnAP ID | M | NG-RAN node UE | Allocated at the source NG-RAN |
| | | XnAP ID | node |
| | | 9.2.3.16 | |
| Target NG-RAN node UE XnAP ID | M | NG-RAN mode UE | Allocated at the target NG-RAN |
| | | XnAP ID | node |
| | | 9.2.3.16 | |
| PDU Session Resources Admitted List | M | 9.2.1.2 | |
| PDU Session Resources Not Admitted List | O | 9.2.1.3 | |
| Target NG-RAN nodes To Source NG-RAN | M | OCTET STRING | Either includes the |
| node Transparent Container | | | HandoverCommand message as |
| | | | defined in subclause 10.2.2 of |
| | | | TS 36.331 [14], if the target NG- |
| | | | RAN node is an ng-eNB, |
| | | | or the HandoverCommand |
| | | | message as defined in subclause |
| | | | 11.2.2 of TS 38.331 [10], if the |
| | | | target NG-RAN node is a gNB. |
| UE Context Kept Indicator | O | 9.2.3.68 | |
| Criticality Diagnostics | O | 9.2.3.3 | |
| DRBs transferred to MN | O | DRB List | In case of DC, indicates that SN |
| | | 9.2.1.29 | Status is needed for the listed |
| | | | DRBs from the S-NG-RAN node. |
| Target Relay UE Information | | | |
| >Target Relay UE ID | O | | |
| >serving cell for target Relay UE | O | | In case the serving cell of Target |
| | | | relay UE is [symbol] |
| | | | [symbol] |

[symbol]

indicates data missing or illegible when filed

As mentioned-above, the HO preparation failure message which may indicate a cause value like “No Radio Resources Available in Target Relay UE” and “Change of the serving cell for Relay UE” may be modified from the legacy message as below:

| | | IE type and | |
|---|---|---|---|
| IE/Group Name | Presence | reference | Semantics description |
| Message Type | M | 9.2.3.1. | |
| Source NG-RAN node UE | M | NG-RAN node | Allocated at the source |
| XnAP ID | | UE XnAP ID | NG-RAN node |
| | | 9.2.3.16 | |
| Cause | M | 9.2.3.2 | |
| Criticality Diagnostics | O | 9.2.3.3 | |
| Requested Target Cell ID | O | Target Cell | Target cell indicated in |
| | | Global ID | the corresponding |
| | | 9.2.3.25 | HANDOVER REQUEST |
| | | | message |
| Requested Target Relay | O | | Target Relay UE |
| UE ID | | | indicated [symbol] the |
| | | | corresponding |
| | | | HANDOVER REQUEST |
| | | | message |

[symbol]

indicates data missing or illegible when filed

As mentioned-above, the HO cancel message which may comprise a newly-defined IE of a target cell ID may be modified from the legacy message as below:

| | | IE type and | |
|---|---|---|---|
| IE/Group Name | Presence | reference | Semantics description |
| Message Type | M | 9.2.3.1 | |
| Source NG-RAN node UE XnAP ID | M | NG-SAN node UE | Allocated at the source |
| | | XnAP ID | NG-RAN node. |
| | | 9.2.3.16 | |
| Target NG-RAN node UE XnAP ID | O | NG-RAN node UE | Allocated at the target |
| | | XnAP ID | NG-RAN node. |
| | | 9.2.3.16 | |
| Cause | M | 9.2.3.2 | |
| Candidate Cells To Be Cancelled | | | |
| List | | | |
| >Target Cell ID | M-O | Target Cell Global ID | |
| | | 9.2.3.25 | |
| Candidate Relay UE To Be | | | |
| Cancelled List | | | |
| >Target Relay UE ID | O | | Target Relay UE |
| | | | indicated in the |
| | | | corresponding |
| | | | HANDOVER REQUEST |
| | | | message |

A text proposal in which the technical features in accordance with the present disclosure are reflected may be presented based on 3GPP TS 38.300 V 17.0.0 as below (the crossline indicates deletion from the legacy description, while underline indicates addition to the legacy description):
3. The source gNB issues a Handover Request message to the target gNB passing a transparent RRC container with necessary information to prepare path switch (such as path switch to Relay UE, or path switch for I2I, or path switch for D2I) at the target side. The information includes at least the target cell ID, KgNB*, the C-RNTI of the UE in the source gNB, RRM-configuration including UE inactive time, basic AS-configuration including antenna Info and DL Carrier Frequency, the current QoS flow to DRB mapping rules applied to the UE, the SIB1 from source gNB, the UE capabilities for different RATs, PDU session related information, target Relay UE related information, and can include the UE reported measurement information including beam-related information if available. The PDU session related information includes the slice information and QoS flow level QoS profile(s). The target Relay UE related information includes the (target) U2N Relay UE ID, RRC context of Relay UE in case of the I2I path switch.
4. Admission Control may be performed by the target gNB. Slice-aware admission control shall be performed if the slice information is sent to the target gNB. If the PDU sessions are associated with non-supported slices the target gNB shall reject such PDU Sessions.
5. The target gNB prepares the path switch_with L1/L2 and sends the HANDOVER REQUEST ACKNOWLEDGE to the source gNB, which includes a transparent container to be sent to the UE as an RRC message to perform the path switch. The target gNB also indicates if a DAPS handover is accepted.
6. The source gNB triggers the path switch by sending an RRCReconfiguration message to the UE, containing the information required to access the target cell and (target) U2N Relay UE ID: at least the target cell ID, the new C-RNTI, the target gNB security algorithm identifiers for the selected security algorithms, (target) U2N Relay UE ID, PC5 Relay RLC channel configuration for relay traffic and the associated end-to-end radio bearer(s).

3GPP TS 38.331 V17.0.0 has defined legacy triggering event such as:
Event X1 (Serving L2 U2N Relay UE becomes worse than threshold1 and NR Cell becomes better than threshold2)
Event Y1 (PCell becomes worse than threshold1 and candidate L2 U2N Relay UE becomes better than threshold2)

A new event for I2I may be added. A text proposal in which the technical features in accordance with the present disclosure are reflected may be presented based on 3GPP TS 38.331 V17.0.0 as below:
Event Z1 (Serving L2 U2N Relay UE becomes worse than threshold1 and candidate L2 U2N Relay UE becomes better than threshold2)
   The UE shall:

1> consider the entering condition for this event to be satisfied when both condition
Z1-1 and condition Z1-2, as specified below, are fulfilled;
1> consider the leaving condition for this event to be satisfied when condition Z1-3 or
condition Z1-4, i.e. at least one of the two, as specified below, is fulfilled;
Inequality Z1-1 (Entering condition 1)
Mr_s + Hys < Thresh 1
Inequality Z1-2 (Entering condition 2)
Mr_c− Hys > Thresh2
Inequality Z1-3 (Leaving condition 1)
Mr_s − Hys > Thresh1
Inequality Z1-4 (Leaving condition 2)
Mr_c + Hys < Thresh2

The variables in the formula are defined as follows:
Mr_s is the measurement result of serving L2 U2N Relay UE, not taking into account any offsets.
Mr_c is the measurement result of the candidate L2 U2N Relay UE, not taking into account any offsets.
Hys is the hysteresis parameter for this event.
Thresh1 is the threshold parameter for this event (i.e. z1-Threshold1-Realy as defined within reportConfigInterRAT for this event).
Thresh2 is the threshold parameter for this event (i.e. z1-Threshold2-Relay as defined within reportConfigInterRAT for this evenevent).
Mr_s is expressed in dBm or dB, depending on the measurement quantity of serving L2 U2N Relay UE.
Mr_c is expressed in dBm or dB, depending on the measurement quantity of candidate L2 U2N Relay UE.
Hys are expressed in dB.
Thresh1 is expressed in the same unit as Mr_s.
Thresh2 is expressed in the same unit as Mr_c.

As illustrated in FIG. 3, after UE1 120-1 establishes 236 PC5 connection 207 with UE2 120-2, and before UE1 120-1 sends 244 RRCReconfiguration complete message 209 to gNB2 110-2, UE1 120-1 may release the PC5 connection 308 with the source relay UE3 120-3. On the other side of the communication, the source relay UE 120-3 may release 342 the PC5 connection 308 with UE1 120-1.

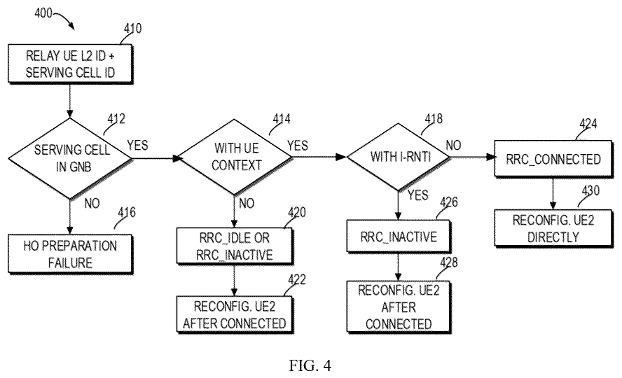

Reference is now made to FIG. 6. FIG. 6 illustrates a flow chart of an example method 600 implemented at the target network device in accordance with some embodiments of the present disclosure. Only for the purpose of discussion, the process 600 will be described with reference to FIGS. 1A, 2B, 4 and 5B. The process 600 may involve gNB2 110-2. FIG. 6 is different from FIG. 4 in that, after the relay UE 120-2 is identified by the target gNB (in this example, gNB2 110-2; the target gNB has the UE context of the relay UE 120-2), if no Uu RLC channel of the relay UE 120-2 is available for relay traffic of UE 120-1, gNB2 110-2 may send HO failure message to the source with new cause value. For simplicity of description, only different points as compared with FIG. 2B will be described below.

For example, as illustrated in FIG. 6, gNB2 110-2 may, at block 618, determine whether a Uu ID (such as an C-RNTI) of the candidate relay UE 120-2 is available. If available (yes), gNB2 110-2 may, at block 424, determine that the candidate relay UE 120-2 is in an RRC_CONNECTED state. Then, the gNB2 110-2 may, at block 630, further determine whether resource is available in target cell (for example, cell 102 as illustrated in FIG. 2B). If the gNB2 110-2 determines that resource is not available in target cell (for example, cell 102 as illustrated in FIG. 2B), gNB2 110-2 may, at block 632, send a HO preparation failure to gNB1 110-1. On the contrary, if the gNB2 110-2 determines that resource is available in target cell, gNB2 110-2 may, at block 634, further determine whether resource is available in target relay UE (for example, UE2 120-2). If not available, gNB2 may, in block 636, send 560 a HO preparation failure 505 to gNB1 110-1, as illustrated in FIG. 5B. If available, gNB2 may, in block 638, gNB2 110-2 may reconfigure the target relay UE (i.e., UE2 120-2) directly, and send a HO preparation acknowledgement message to gNB1 110-1.

It is to be noted that, in block 636, when the HO preparation failure 505 is sent 560 from gNB2 110-2 to gNB1 110-1, the HO preparation failure 505 may include a cause value which is newly-defined to indicate that there is no resource available in the target cell (for example, cell 102 as illustrated in FIG. 2B).

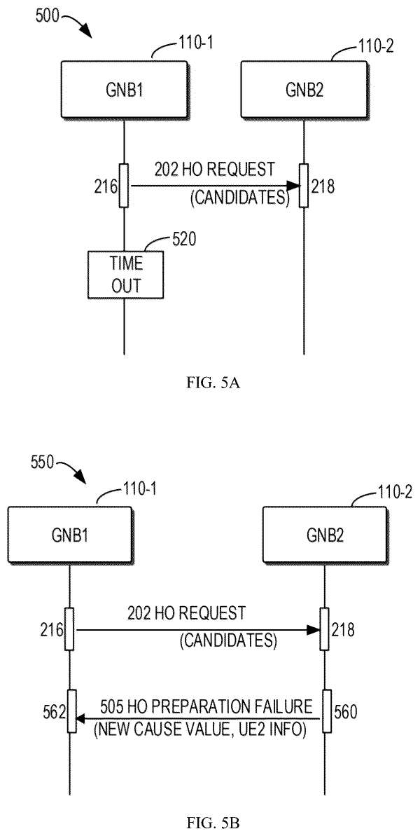

Reference is now made to FIG. 7. FIG. 7 illustrates a flow chart of an example method 700 in accordance with some embodiments of the present disclosure. Only for the purpose of discussion, the process 600 will be described with reference to FIGS. 1A, 2B, 4 and 5B. The process 700 may involve gNB2 110-2. FIG. 7 is different from FIG. 4 in that, after the relay UE is determined to be in RRC_CONNECTED state, gNB2 110-2 may further determine whether serving cell matches the latest cell. For simplicity of description, only different points as compared with FIG. 2B will be described below.

As illustrated in FIG. 7, gNB2 110-2 determines, in block 424, that target relay UE (in this example, UE 120-2 as illustrated in FIG. 2B) is in RRC_CONNECTED state. Then, gNB2 110-2 may, in block 726, further determine whether serving cell (for example, cell 102, which may be transmitted from gNB1 110-1 to gNB2 110-2 in the HO request 202, as illustrated in FIG. 2) of the target UE (i.e., UE 120-2) is the latest cell of the target UE. The serving cell of UE 120-2 may change, for example, because of movement of UE 120-2. If the serving cell is not the latest cell, gNB2 110-2 may further determine, for example, whether the latest cell of the target UE (i.e., UE 120-2) is under control of (or, managed by) the target gNB (in this example, gNB2 110-2 as illustrated in FIG. 2B). If the latest cell of the UE 120-2 is also managed by gNB2 110-2, the gNB2 110-2 may send 220 a HO acknowledgement message 203 and reconfigure the target relay UE 120-2 directly. However, if the latest cell of the UE 120-2 is not managed by gNB2 110-2, namely, managed by a gNB other than gNB2, then gNB2 110-2 may send 560 a HO preparation failure message 505 to gNB1 110-1 as illustrated in FIG. 5B. In this case, the HO preparation failure message 505 may include a cause value which indicates there is change of the serving cell for relay UE.

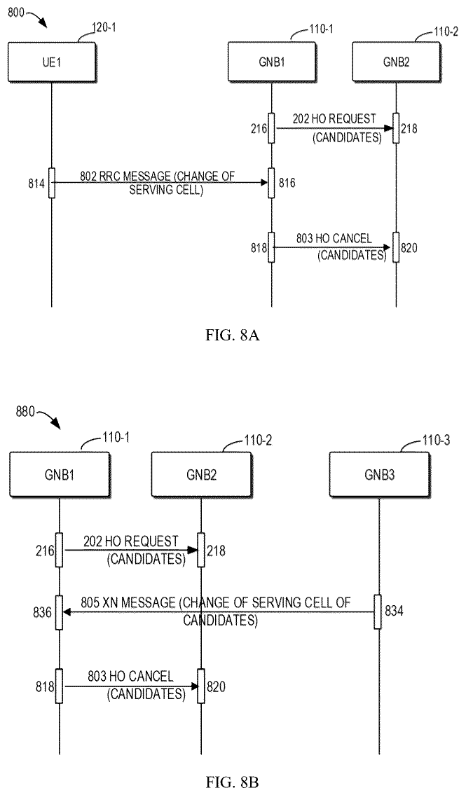

FIG. 9 illustrates a signaling chart illustrating communication process 900 in accordance with some embodiments of the present disclosure. Only for the purpose of discussion, the process 900 will be described with reference to FIGS. 1A and 2B. The process 900 may involve gNB2 110-2 and UE1 120-1 and UE2 120-2.

As illustrated in FIG. 9, gNB1 110-1 may send 910 a signaling 901 to UE2 120-2 to configure the transmission of RRC state. For example, the signaling 901 may comprise a first indicator to indicate the transmission of RRC state. For the first indicator, it may be a 1-bit value, value “0” indicates to transmit RRC state, and value “1” indicates to not to transmit RRC state. On the other side of communication, UE2 120-2 may receive 912 the signaling 901. Alternatively, the first indicator may be a Boolean, which is true for transmission and false for no transmission.

UE1 120-1 and UE2 120-2 may send a discovery message 902 to each other. In other words, UE1 120-1 may send 916 a discovery message 902 to UE2 120-2, and the UE2 120-2 may receive 914 the discovery message 902. On the other side of communication, UE2 120-2 may send 914 a discovery message 902 to UE1 120-1, and the UE1 120-12 may receive 916 the discovery message 902.

gNB1 110-1 may send 918, a signaling 903 to UE1 120-1, to configure the report of RRC state of UE2 120-2. On the other side of communication, UE1 120-1 may receive 920, the signaling 903 from gNB2 110-2. For example, the signaling 903 may comprise a second indicator to indicate the report of RRC state of UE2 120-2. For the second indicator, it may be a 1-bit value, value “0” indicates to report RRC state of candidate rely UE 120-2, and value “1” indicates to not to report RRC state of candidate rely UE 120-2. Alternatively, the second indicator may be a Boolean, value “true” indicates to report RRC state of candidate rely UE 120-2, and value “false” indicates to not to report RRC state of candidate rely UE 120-2.

UE1 120-1 then may, send 922 measurement report 904 with RRC state information of UE2 120-2 to gNB1 110-1 in accordance with the received signaling 903. For example, if the second indicator is set to value “0” when it is a 1-bit value or value “true” when it is a Boolean value, RRC state of the candidate relay UE 120-2 is comprised in the measurement report 904 to be sent 922 by UE1 120-1 to gNB1 110-1. On the other side of communication, gNB1 110-1 receives 924 the measurement report 904 comprising RRC state of the candidate relay UE 120-2.

In response to receipt 924 of the measurement report 904, the gNB1 110-1 may select only RRC_CONNECTED candidate relay UE(s) for HO request to gNB2 110-2.

In some example embodiments of the present disclosure, as illustrated in FIG. 9, UE1 120-1 performs measurement and selects candidate relay UE(s). UE1 120-1 may report candidate relay UE(s) and its state to its serving network device, i.e., gNB1 110-1. In one example, UE1 120-1 may report a first UE ID (e.g., L2 ID), serving cell and state information (e.g., 2 bits) of the candidate relay UE(s) to gNB1 110-1. In another example, UE1 120-1 may report a first UE ID (e.g., L2 ID), serving cell and a second UE ID (e.g., I-RNTI, C-RNTI or 5G-S-TMSI/5G-TMSI) of the candidate relay UE(s) to gNB1 110-1.

In some example embodiments of the present disclosure, as illustrated in FIG. 9, gNB1 110-1 may only select connected UE as candidate relay UE(s) whose information may be transmitted to the target gNB. In one example, for explicit information, gNB2 110-2 may select connected UE directly. In another example, for implicit information, gNB2 110-2 may derive the state of the candidate relay UE(s) first, then select connected UE(s).

In some example embodiments of the present disclosure, it can be configured by gNB whether to only report RRC_CONNECTED relay UE(s). For example, gNB1 110-1, the serving network device for UE1 120-1, may configure UE1 120-1 to only report RRC_CONNECTED relay UE(s). Such configuration may be realized via SIB(SIB1, new SIB specified for sidelink relay) or RRC signaling (e.g. RRCReconfiguration message).

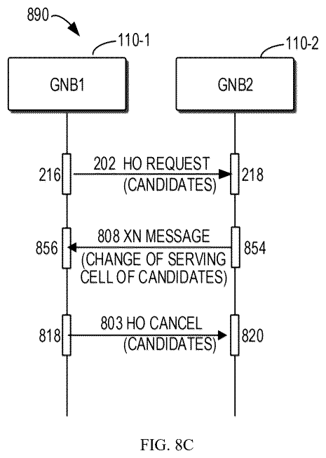

FIG. 10 illustrates a signaling chart illustrating communication process 1000 in accordance with some embodiments of the present disclosure. Only for the purpose of discussion, the process 1000 will be described with reference to FIGS. 1A and 2B. The process 1000 may involve gNB2 110-2 and UE1 120-1 and UE2 120-2.

In some example embodiments of the present disclosure, as illustrated in FIG. 10, UE1 120-1 and UE2 120-2 mutually discover each other via a discovery message 1001. Then, UE1 120-1 may send 1014 a SUI or UAI message 1002 to its serving network device, namely, gNB1 110-1. The SUI or UAI message 1002 may comprise L2 ID and/or UuID of UE1 120-1 and UE2 120-2. On the other side of communication, gNB1 110-1 may receive 1016 the SUI or UAI message 1002 from UE1 120-1. Then gNB1 110-1 may map 1018 from UE ID to L2 ID of UE1 120-1.

In some example embodiments of the present disclosure, as illustrated in FIG. 10, UE1 120-1 may further perform measurement and send 1024 a measurement report 1004 to the gNB1 110-1. The measurement report 1004 may comprise L2 ID and serving cell ID of the candidate relay UEs 120-2. On the other side of communication, gNB1 110-1 may receive 1026 the measurement report 1004. Then gNB1 110-1 may look up the RRC state of the candidate relay UE2 120-2.

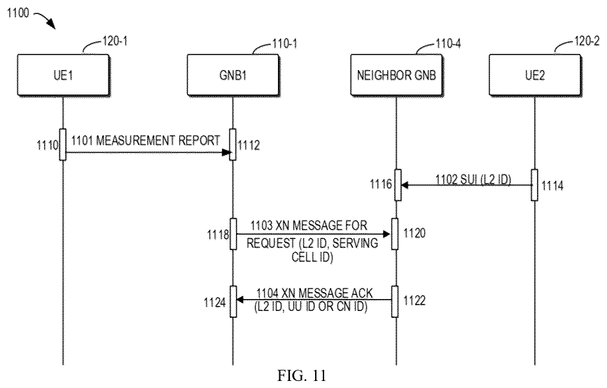

FIG. 13 illustrates a flowchart of an example method 1300 in accordance with some embodiments of the present disclosure. For the purpose of discussion, the method 1300 will be described from the perspective of the network device 110-1 with reference to FIGS. 1A and 2B.

At block 1310, the first network device 110-1 determines a path switch for a terminal device 120-1 from a first path including the first network device 110-1 to a second indirect path including a second network device 110-2.

At block 1320, the first network device 110-1 transmits, to the second network device 110-2, a handover request message including first information to indicate the path switch to a candidate relay user equipment (UE) for the second indirect path and second information on the candidate relay UE.

In some example embodiments, the second information comprises at least one of: an identifier (ID) of the candidate relay UE, cell information of the candidate relay UE, and a measurement result for the candidate relay UE.

In some example embodiments, the second information comprises at least one of: a list of IDs of a plurality of candidate relay UEs including the candidate relay UE, lists of serving cells of the plurality of candidate relay UEs, a list of radio resource control (RRC) contexts of the plurality of candidate relay UEs, and lists of measurement results for the plurality of candidate relay UEs.

In some example embodiments, at least one of the following conditions are met: the plurality of candidate relay UEs belong to a same target cell indicated by the cell information, the cell information indicates at least one serving cell corresponding to each of the plurality of candidate relay UEs, an order of the plurality of candidate relay UEs is based on the plurality of measurement results, an order of the lists of serving cells is based on the order of the plurality of candidate relay UEs, an order of the RRC contexts is based on the order of the plurality of candidate relay UEs, and an order of the lists of measurement results is based on the order of the plurality of candidate relay UEs.

In some example embodiments, the method 1300 further comprises: receiving, from the second network device, a handover acknowledgement message including a handover command for the terminal device.

In some example embodiments, the handover acknowledgement message comprises at least one of: a Layer 2 (L2) ID of a selected relay UE, information on a serving cell of the selected relay UE, a local ID of the terminal device, a PC5 Relay RLC channel configuration for a relay traffic, information on an end-to-end radio bearer, and a plurality of IDs of a set of selected relay UEs.

In some example embodiments, receiving the handover acknowledgement message comprises: receiving, from the second network device, a plurality of handover acknowledgement messages for a set of selected relay UEs, the handover acknowledgement message being one of the plurality of handover acknowledgement messages.

In some example embodiments, the first information comprises a cause value indicating that the handover request message is for at least one of: a sidelink path switch, a sidelink path switch to a relay UE, a sidelink path switch from a gNB to a relay UE, a sidelink path switch from relay to another relay UE, a sidelink path switch from an indirect path to another indirect path, and a sidelink path switch from a direct path to an indirect path.

In some example embodiments, transmitting the handover request message comprises: transmitting a plurality of handover request messages to the second network device, the handover request message being one of the plurality of handover request messages, a first one of the plurality of handover request messages including a UE context of the terminal device.

In some example embodiments, the first path is a first indirect path including a source relay UE and the handover request message includes at least one of: a UE context of the source relay UE, an RRC context of the source relay UE, a radio resource management (RRM) configuration of the source relay UE, a local ID of the terminal device, a temporary ID of the terminal device, and an L2 ID of the terminal device.

In some example embodiments, the first path is a first indirect path and determining to perform the path switch comprises: in response to determining that a serving relay UE in the first indirect path becomes worse than a first threshold and a candidate relay UE for the second indirect path becomes better than a second threshold, determining to perform the path switch.

In some example embodiments, the method 1300 further comprises: in response to expiry of a timer for receiving a handover feedback message from the second network device, determining a failure of the path switch.

In some example embodiments, the method 1300 further comprises: receiving, from the second network device, a handover preparation failure message associated with the candidate relay UE.

In some example embodiments, the handover preparation failure message includes at least one of: a cause value indicating a reason of the handover preparation failure, and an ID of the candidate relay UE.

In some example embodiments, the reason is at least one of: no radio resource available in the candidate relay UE, a change of a serving cell for the candidate relay UE, the candidate relay UE being unavailable, an ID of the candidate relay UE being unknown to the second network device, the candidate relay UE not allowing the path switch, and the candidate relay UE not supporting a 5QI value of the second indirect path.

In some example embodiments, the method 1300 further comprises: in response to receiving the handover preparation failure message, transmitting a further handover request message to the second network device, the further handover request message including third information on a further candidate relay UE for the second indirect path.

In some example embodiments, the method 1300 further comprises: in response to determining to cancel the path switch, transmitting a handover cancel message to the second network device.

In some example embodiments, the handover cancel message includes at least one of: a value indicating that a target cell of the candidate relay UE is unknown to the first network device, a value indicating a change of a serving cell of the candidate relay UE, an ID of the candidate relay UE, and a plurality of IDs of a set of candidate relay UEs.

In some example embodiments, the method 1300 further comprises: determining the change of the serving cell of the candidate relay UE based on receiving at least one of: an explicit indication of the change of the serving cell of the candidate relay UE, and an implicit indication of a latest serving cell of the candidate relay UE different from a serving cell of the candidate relay UE in the handover request message.

In some example embodiments, at least one of the explicit indication and the implicit indication is received via at least one of: a report from the terminal device, a notification from a latest serving network device of the candidate relay UE; and a notification from a target network device of the terminal device.

In some example embodiments, an information element (IE) of a target cell ID in the handover cancel message is one of: mandatorily present, optionally present, and mandatorily present but ignored if a cause value of the handover cancel message is set to indicate a reason of a failure associated with the candidate relay UE.

In some example embodiments, the handover cancel message is a custom Xn message.

In some example embodiments, the ID of the candidate relay UE comprises at least one of: an integer multiple of 8 bits, an L2 ID reported by the terminal device, a Uu ID, a core network ID, and a combination of the L2 ID and the Uu ID or the core network ID.

In some example embodiments, the method 1300 further comprises: receiving the ID of the candidate relay UE from the terminal device.

In some example embodiments, the ID of the candidate relay UE is received via at least one of a measurement report and assistance information.

In some example embodiments, the method 1300 further comprises: transmitting, to a neighbor network device, a first Xn message including an L2 ID and a serving cell ID of the candidate relay UE; and receiving, from the neighbor network device, a second Xn message including the L2 ID and a Uu ID or a core network device ID of the candidate relay UE.

In some example embodiments, at least one of the following conditions are met: the first Xn message being a sidelink information request, the second Xn message being a sidelink information acknowledgement, the first Xn message including information on a plurality of candidate relay UEs, the second Xn message including information on the plurality of candidate relay UEs, the first Xn message being triggered periodically or triggered by a measurement report from the terminal device, the first Xn message further requesting a RRC state of the candidate relay UE, the first Xn message further requesting a latest serving cell of the candidate relay UE, the second Xn message further including a RRC state of the candidate relay UE, and the second Xn message further including a latest serving cell of the candidate relay UE.

In some example embodiments, the method 1300 further comprises: receiving, from the neighbor network device, a third Xn message including the L2 ID and a Uu ID or a core network device ID of the candidate relay UE; and transmitting, to a neighbor network device, a fourth Xn message as an acknowledgement to the third Xn message.

In some example embodiments, at least one of the following conditions are met: the third Xn message being a sidelink information announcement, the third Xn message including information on a plurality of candidate relay UEs, the fourth Xn message including information on the plurality of candidate relay UEs, the third Xn message further announcing a RRC state of the candidate relay UE, and the third Xn message further announcing a latest serving cell of the candidate relay UE.

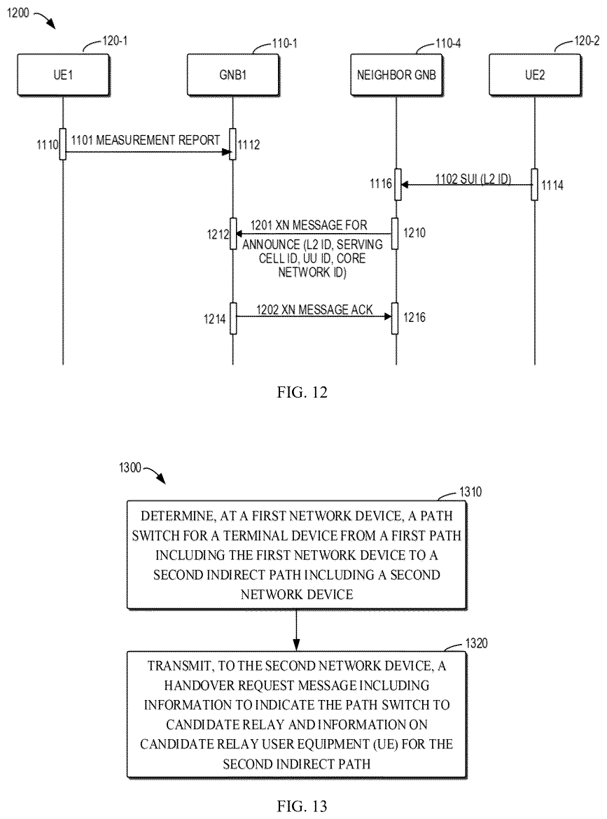

FIG. 14 illustrates a flowchart of an example method 1400 in accordance with some embodiments of the present disclosure. For the purpose of discussion, the method 1400 will be described from the perspective of the network device 110-2 with reference to FIGS. 1A and 2B.

At block 1410, the second network device 110-2 receives, from a first network device 110-1, a handover request message for a path switch associated with a terminal device 120-1 from a first path including the first network device 110-1 to a second indirect path including the second network device 110-2, the handover request message including first information to indicate the path switch to a candidate relay UE for the second indirect path and second information on the candidate relay UE (such as UE 120-2 as illustrated in FIG. 2B).

At block 1420, the second network device 110-2 transmits, to the candidate relay UE 120-2, a radio resource control (RRC) reconfiguration message for the path switch.

In some example embodiments, the second information comprises at least one of: an identifier (ID) of the candidate relay UE, cell information of the candidate relay UE, and a measurement result for the candidate relay UE.

In some example embodiments, the second information comprises at least one of: a list of IDs of a plurality of candidate relay UEs including the candidate relay UE, lists of serving cells of the plurality of candidate relay UEs, a list of RRC contexts of the plurality of candidate relay UEs, and lists of measurement results for the plurality of candidate relay UEs.

In some example embodiments, at least one of the following conditions are met: the plurality of candidate relay UEs belong to a same target cell indicated by the cell information, the cell information indicates at least one serving cell corresponding to each of the plurality of candidate relay UEs, an order of the plurality of candidate relay UEs is based on the plurality of measurement results, an order of the lists of serving cells is based on the order of the plurality of candidate relay UEs, an order of the RRC contexts is based on the order of the plurality of candidate relay UEs, and an order of the lists of measurement results is based on the order of the plurality of candidate relay UEs.

In some example embodiments, the method 1400 further comprises: in response to determining that a serving cell of the candidate relay UE is not managed by the second network device, transmitting a handover preparation failure message to the first network device; in response to determining that a UE context of the candidate relay UE is found and the candidate relay UE is in an RRC_CONNECTED state, transmitting the RRC reconfiguration message directly; and in response to determining that the UE context is found and the candidate relay UE is in an RRC_INACTIVE state, transmitting the RRC reconfiguration message after the candidate relay UE enters the RRC_CONNECTED state.

In some example embodiments, the method 1400 further comprises: in response to successful operation of a handover preparation in the second network device, transmitting, to the first network device, a handover acknowledgement message including a handover command for the terminal device.

In some example embodiments, the handover acknowledgement message comprises at least one of: a Layer 2 (L2) ID of a selected relay UE, information on a serving cell of the selected relay UE, a local ID of the terminal device, a PC5 Relay RLC channel configuration for a relay traffic, information on an end-to-end radio bearer, and a plurality of IDs of a set of selected relay UEs.

In some example embodiments, transmitting the handover acknowledgement message comprises: transmitting, to the first network device, a plurality of handover acknowledgement messages for a set of selected relay UEs, the handover acknowledgement message being one of the plurality of handover acknowledgement messages.

In some example embodiments, the handover request message includes a cause value indicating that the handover request message is for at least one of: a sidelink path switch, a sidelink path switch to a relay UE, a sidelink path switch from a gNB to a relay UE, a sidelink path switch from relay to another relay UE, a sidelink path switch from an indirect path to another indirect path, and a sidelink path switch from a direct path to an indirect path.

In some example embodiments, receiving the handover request message comprises: receiving a plurality of handover request messages from the first network device, the handover request message being one of the plurality of handover request messages, a first one of the plurality of handover request messages including a UE context of the terminal device.

In some example embodiments, the first path is a first indirect path including a source relay UE and the handover request message includes at least one of: a UE context of the source relay UE, an RRC context of the source relay UE, a radio resource management (RRM) configuration of the source relay UE, a local ID of the terminal device, a temporary ID of the terminal device, and an L2 ID of the terminal device.

In some example embodiments, the method 1400 further comprises: in response to determining a handover preparation failure associated with the candidate relay UE, transmitting a handover preparation failure message to the first network device.

In some example embodiments, the method 1400 further comprises: in response to determining that a serving cell of the candidate relay UE indicated in the handover request message is changed, but a latest serving cell of the candidate relay UE is still under control of the second network device, transmitting a handover acknowledgement message to the first network device.

In some example embodiments, the handover preparation failure message includes at least one of: a cause value indicating a reason of the handover preparation failure, and an ID of the candidate relay UE.

In some example embodiments, the reason is at least one of: no radio resource available in the candidate relay UE, a change of a serving cell for the candidate relay UE, the candidate relay UE being unavailable, an ID of the candidate relay UE being unknown to the second network device, the candidate relay UE not allowing the path switch, and the candidate relay UE not supporting a 5QI value of the second indirect path.

In some example embodiments, the method 1400 further comprises: receiving a further handover request message from the first network device, the further handover request message including third information on a further candidate relay UE for the second indirect path.

In some example embodiments, the method 1400 further comprises: receiving a handover cancel message from the first network device.

In some example embodiments, the handover cancel message includes at least one of: a value indicating that a target cell of the candidate relay UE is unknown to the first network device, a value indicating a change of a serving cell of the candidate relay UE, and an ID of the candidate relay UE.

In some example embodiments, an information element (IE) of a target cell ID in the handover cancel message is one of: mandatorily present, optionally present, and mandatorily present but ignored if a cause value of the handover cancel message is set to indicate a reason of a failure associated with the candidate relay UE.

In some example embodiments, the handover cancel message is a custom Xn message.

In some example embodiments, the ID of the candidate relay UE comprises at least one of: an integer multiple of 8 bits, an L2 ID reported by the terminal device, a Uu ID, a core network ID, and a combination of the L2 ID and the Uu ID or the core network ID.

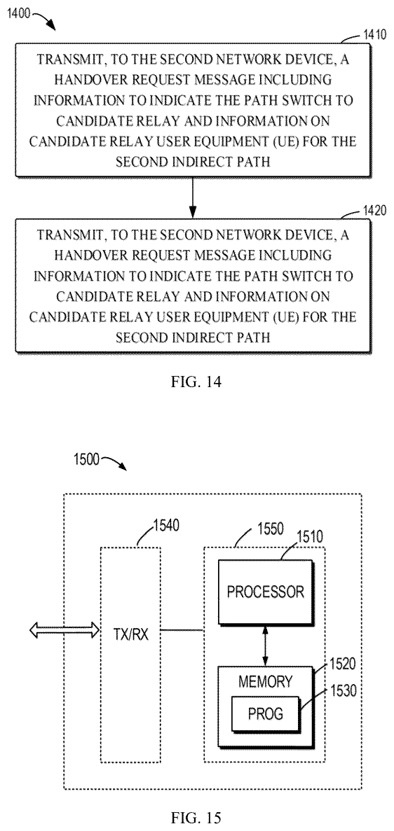

FIG. 15 illustrates a simplified block diagram of a device 1500 that is suitable for implementing embodiments of the present disclosure. The device 1500 can be considered as a further example implementation of the terminal device 120 and/or the network device 110 as shown in FIG. 1. Accordingly, the device 1500 can be implemented at or as at least a part of the terminal device 120 or the network device 110.

As shown, the device 1500 includes a processor 1510, a memory 1520 coupled to the processor 1510, a suitable transmitter (TX) and receiver (RX) 1540 coupled to the processor 1510, and a communication interface coupled to the TX/RX 1540. The memory 1510 stores at least a part of a program 1530. The TX/RX 1540 is for bidirectional communications. The TX/RX 1540 has at least one antenna to facilitate communication, though in practice an Access Node mentioned in this disclosure may have several ones. The communication interface may represent any interface that is necessary for communication with other network elements, such as X2 interface for bidirectional communications between eNBs, Si interface for communication between a Mobility Management Entity (MME)/Serving Gateway (S-GW) and the eNB, Un interface for communication between the eNB and a relay node (RN), or Uu interface for communication between the eNB and a terminal device.

The program 1530 is assumed to include program instructions that, when executed by the associated processor 1510, enable the device 1500 to operate in accordance with the embodiments of the present disclosure, as discussed herein with reference to FIGS. 3-14. The embodiments herein may be implemented by computer software executable by the processor 1510 of the device 1500, or by hardware, or by a combination of software and hardware. The processor 1510 may be configured to implement various embodiments of the present disclosure. Furthermore, a combination of the processor 1510 and memory 1520 may form processing means 1550 adapted to implement various embodiments of the present disclosure.

The memory 1520 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1520 is shown in the device 1500, there may be several physically distinct memory modules in the device 1500. The processor 1510 may be of any type suitable to the local technical network, and may include one or more of general purpose computers, special purpose computers, microprocessors, digital signal processors (DSPs) and processors based on multicore processor architecture, as non-limiting examples. The device 1500 may have multiple processors, such as an application specific integrated circuit chip that is slaved in time to a clock which synchronizes the main processor.

The present disclosure may also provide the following solutions.

The present disclosure provides a terminal device, comprising: a processor; and a memory storing computer program codes; the memory and the computer program codes configured to, with the processor, cause the terminal device to perform the method implemented at the terminal device 120-1 discussed above.

The present disclosure provides a network device, comprising: a processor; and a memory storing computer program codes; the memory and the computer program codes configured to, with the processor, cause the network device to perform the method implemented at the first network device 110-1 and/or the second network device 110-2 discussed above.

The present disclosure provides a computer readable medium having instructions stored thereon, the instructions, when executed by a processor of an apparatus, causing the apparatus to perform the method implemented at a terminal device 120-1 or at the first network device 110-1 and/or the second network device 110-2 discussed above.

The present disclosure provides solutions by reusing legacy handover messages such as HO request message, HO acknowledge message, HO cancel and HO preparation failure. Alternatively, new message types specific for the preparation of path switch may also be newly defined, for example with the name “SL PATH SWITCH REQUEST” message, “SL PATH SWITCH ACKNOWLEDGE” message, “SL PATH SWITCH PREPARATION FAILURE” message and “SL PATH SWITCH CANCLE” message. In this case, legacy handover messages may be left unchanged and these newly-defined “SL PATH SWITCH” messages are used to realize the functions of the reused HO messages as described in the present disclosure. When these newly-defined “SL PATH SWITCH” messages are used to realize the functions of the reused HO messages as described in the present disclosure, they may comprise the same information element(s) and parameter(s) as the reused HO messages as described in the present disclosure. It should be understood the names of these newly-defined messages are discussed only for the purpose of enabling those skilled persons in the art to better understand and thus implement the subject matter described herein, rather than suggesting any limitations on the scope of the subject matter.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 6-20. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method for communication, comprising:
determining, at a first network device, to perform a path switch for a terminal device from a first path including the first network device to a second indirect path including a second network device; and
transmitting, to the second network device, a handover request message including first information to indicate the path switch to a candidate relay user equipment (UE) for the second indirect path and second information on the candidate relay UE.

2. The method of claim 1, wherein the second information comprises at least one of:
an identifier (ID) of the candidate relay UE,
cell information of the candidate relay UE, and
a measurement result for the candidate relay UE.

3. The method of claim 1, wherein the second information comprises at least one of:
a list of IDs of a plurality of candidate relay UEs including the candidate relay UE,
lists of serving cells of the plurality of candidate relay UEs,
a list of radio resource control (RRC) contexts of the plurality of candidate relay UEs, and
lists of measurement results for the plurality of candidate relay UEs.

4. The method of claim 3, wherein at least one of:
the plurality of candidate relay UEs belong to a same target cell indicated by the cell information,
the cell information indicates at least one serving cell corresponding to each of the plurality of candidate relay UEs,
an order of the plurality of candidate relay UEs is based on the plurality of measurement results,
an order of the lists of serving cells is based on the order of the plurality of candidate relay UEs,
an order of the RRC contexts is based on the order of the plurality of candidate relay UEs, and
an order of the lists of measurement results is based on the order of the plurality of candidate relay UEs.

5. The method of claim 1, further comprising:
receiving, from the second network device, a handover acknowledgement message including a handover command for the terminal device.

6. The method of claim 5, wherein the handover acknowledgement message comprises at least one of:
a Layer 2 (L2) ID of a selected relay UE,
information on a serving cell of the selected relay UE,
a local ID of the terminal device,
a PC5 Relay RLC channel configuration for a relay traffic,
information on an end-to-end radio bearer, and
a plurality of IDs of a set of selected relay UEs.

7. The method of claim 1, wherein the first information comprises a cause value indicating that the handover request message is for at least one of:
a sidelink path switch,
a sidelink path switch to a relay UE,
a sidelink path switch from a gNB to a relay UE,
a sidelink path switch from relay to another relay UE,
a sidelink path switch from the first path to the second path, the first path being an indirect path via another terminal device, and
a sidelink path switch from the first path to the second path, the first path being a direct path.

8. The method of claim 1, wherein the first path is a first indirect path including a source relay UE and the handover request message includes at least one of:
a UE context of the source relay UE,
an RRC context of the source relay UE,
a radio resource management (RRM) configuration of the source relay UE,
a local ID of the terminal device,
a temporary ID of the terminal device, and
an L2 ID of the terminal device.

9. The method of claim 1, further comprising:
receiving, from the second network device, a handover preparation failure message associated with the candidate relay UE.

10. The method of claim 9, wherein the handover preparation failure message includes at least one of:
a cause value indicating a reason of the handover preparation failure, and
an ID of the candidate relay UE.

11. The method of claim 10, wherein the reason is at least one of:
no radio resource available in the candidate relay UE,
a change of a serving cell for the candidate relay UE,
the candidate relay UE being unavailable,
an ID of the candidate relay UE being unknown to the second network device,
the candidate relay UE not allowing the path switch, and
the candidate relay UE not supporting a 5QI value of the second indirect path.

12. The method of claim 1, further comprising:
in response to determining to cancel the path switch, transmitting a handover cancel message to the second network device.

13. The method of claim 12, wherein the handover cancel message includes at least one of:
a value indicating that a target cell of the candidate relay UE is unknown to the first network device,
a value indicating a change of a serving cell of the candidate relay UE,
an ID of the candidate relay UE, and
a plurality of IDs of a set of candidate relay UEs.

14. The method of claim 2, wherein the ID of the candidate relay UE comprises at least one of:
an integer multiple of 8 bits,
an L2 ID reported by the terminal device,
a Uu ID,
a core network ID, and
a combination of the L2 ID and the Uu ID or the core network ID.

15. A method for communication, comprising:
receiving, at a second network device from a first network device, a handover request message for a path switch associated with a terminal device from a first path including the first network device to a second indirect path including the second network device, the handover request message including first information to indicate the path switch to a candidate relay user equipment (UE) for the second indirect path and second information on the candidate relay UE; and
transmitting, to the candidate relay UE, a radio resource control (RRC) reconfiguration message for the path switch.

16. The method of claim 15, wherein the second information comprises at least one of:
an identifier (ID) of the candidate relay UE,
cell information of the candidate relay UE, and
a measurement result for the candidate relay UE.

17. The method of claim 15, further comprising:
in response to determining that a serving cell of the candidate relay UE indicated in the handover request message is changed, but a latest serving cell of the candidate relay UE is still under control of the second network device, transmitting a handover acknowledgement message to the first network device.

18. A first network device comprising:
a processor; and
a memory storing computer program codes;
the memory and the computer program codes configured to, with the processor, cause the terminal device to perform the method of any of claims 1-14.

19. A second network device comprising:
a processor; and
a memory storing computer program codes;
the memory and the computer program codes configured to, with the processor, cause the network device to perform the method of any of claims 15-17.

20. A computer readable medium having instructions stored thereon, the instructions, when executed by a processor of an apparatus, causing the apparatus to perform the method of any of claims 1-17.
